(19) United States
(12) Patent Application Publication
(10) Pub. No.: US 2013/0177835 A1
(43) Pub. Date: Jul. 11, 2013

(54) PROTON CONDUCTOR AND METHOD OF PRODUCING PROTON CONDUCTOR

(71) Applicants: Song-Yul Oh, Toyohashi-shi (JP); Toshihiro Yoshida, Toyohashi-shi (JP); Go Kawamura, Toyohashi-shi (JP); Atsunori Matsuda, Toyohashi-shi (JP); Hiroyuki Muto, Toyohashi-shi (JP); Daisuke Uchihori, Asakura-shi (JP)

(72) Inventors: Song-Yul Oh, Toyohashi-shi (JP); Toshihiro Yoshida, Toyohashi-shi (JP); Go Kawamura, Toyohashi-shi (JP); Atsunori Matsuda, Toyohashi-shi (JP); Hiroyuki Muto, Toyohashi-shi (JP); Daisuke Uchihori, Asakura-shi (JP)

(73) Assignee: National University Corporation TOYOHASHI UNIVERSITY OF TECHNOLOGY, Toyohashi-shi, Aichi-ken (JP)

(21) Appl. No.: 13/811,587

(22) PCT Filed: Jul. 22, 2011
(86) PCT No.: PCT/JP2011/066666

§ 371 Date: Mar. 26, 2013

(30) Foreign Application Priority Data
Jul. 23, 2010 (JP) 2010-165497

(51) Int. Cl. H01M 8/10

(52) U.S. Cl. CPC H01M 8/1016
USPC 429/495

(57) ABSTRACT

By using a composite material that is produced from an acid salt of an oxo acid compound and an azole compound, a proton conductor with good proton conductivity properties under medium temperature, non-humidified conditions may be achieved. The composite material may be produced by mechanical milling of the acid salt of the oxo acid compound and the azole compound using a planetary ball mill The structure of the composite material obtained by the mixing processing may be different from that of a mixture of the acid salt of the oxo acid compound and the azole compound. Therefore, it may be possible to produce the proton conductor that has good proton conductivity properties under medium temperature, non-humidified conditions with a simple method of mechanical mixing.

### TECHNICAL FIELD

The present invention relates to a proton conductor that is used in a fuel cell that operates under medium temperature, non-humidified conditions, and a method of producing the proton conductor.

### BACKGROUND ART

Fuel cells are widely known as a clean power generation system. As one type of such a fuel cell, a fuel cell that operates approximately at 80° C. under humidified conditions by using a fluorinated solid polymer electrolyte has been proposed. Moreover, it is expected that a medium temperature dry fuel cell (MTDFC) that operates in a medium temperature region of 100° C. to 250° C. under non-humidified conditions will be developed.

The MTDFC has the following advantages compared with the above-mentioned fuel cell that uses a fluorinated solid polymer electrolyte. First, the MTDFC does not require a humidifier because water for proton conduction is not necessary, thus making it possible to make the device smaller. Second, the CO resistance can be improved by operating the MTDFC at 100° C. or more. In other words, catalyst poisoning can be substantially reduced, so it is possible to reduce the amount of Pt used and to simplify a reformed gas system. Third, a cooling system can be simplified by the increase in operating temperature and the total energy utilization rate can be improved by utilizing exhaust heat.

An electrolyte membrane with a basic structure of polybenzimidazole (PBI) as an electrolyte membrane to be used in the MTDFC has been proposed (refer to Patent Literature 1, for example). The electrolyte membrane disclosed in Patent Literature 1 contains PBI, an inorganic acid, and adenylic acid, and can exhibit high proton conductivity properties by doping phosphoric acid.

Meanwhile, as a proton conductor that is used for an electrolyte in the MTDFC, an ionic liquid has been proposed as an alternative to water. The ionic liquid is a substance that is liquid at room temperature and is produced by adding an acidic substance to a basic solid that has proton conductivity properties such as imidazol. The ionic liquid has generally better thermal stability and significantly better ionic conductivity properties than the basic solid itself. For example, it is reported that the ionic liquid produced by mixing imidazole with bis(trifluoromethanesulfonyl)imide (HTFSI) (imidazole:HTFSI=9:1) has proton conductivity properties of 10⁻¹ Scm⁻¹ at 120° C. while imidazole has the proton conductivity of 10⁻³ Scm⁻¹ at 90° C. or more (refer to Non-Patent Literature 1, for example).

Recently, a proton conductor produced by mixing this ionic liquid and heteropoly acid has been proposed in an effort to achieve both higher stability as an electrolyte and high proton conductivity properties (refer to Patent Literature 2, for example).

### CITATION LIST

### Patent Literature

Patent Literature 1: Japanese Laid-Open Patent Publication No. 2008-218299

Patent Literature 2: Japanese Laid-Open Patent Publication No. 2009-16156

### Non-Patent Literature

Non-Patent Literature 1: A. Noda et al., J. Phys. Chem. B, 107, 4024 (2003)

### SUMMARY OF INVENTION

However, in the technology disclosed in Patent Literature 1, the doped phosphoric acid may leak and seep out of the electrolyte membrane with the passing of time. Therefore, in a case where the conductivity has been improved by doping with a large amount of phosphoric acid, phosphoric acid that has leaked and seeped out may corrode peripheral members in a case where the membrane is used for a long time.

Meanwhile, in the technology disclosed in Non-Patent Literature 1, there is a concern about liquid leakage because the electrolyte is liquid. The presence of counter ions that are not involved in proton transport may cause the proton transport number to decrease. It may be difficult to achieve high battery energy density by forming the electrolyte into a thin film because the electrolyte is liquid.

In the technology disclosed in Patent Literature 2, an attempt has been made to stabilize the ionic liquid and thus reduce its fluidity. This may solve elution causing liquid leakage etc. However, the ionic liquid still contains the counter ions, so it may not be possible to solve the decrease in the proton transport number. In this technology, proton conductivity properties may become poor in a temperature region of 140° C. or less since the proton conductivity properties at 140° C. or less drop compared to the ionic liquid. Therefore, in a case where a fuel cell is manufactured using the proton conductor disclosed in Patent Literature 2 for its electrolyte, it is necessary to wait for a certain amount of time for the fuel cell to actually start generating power after operation starts. In other words, when the fuel cell is actually operated, quick power generation cannot be realized, which may lead to a decrease in user usability.

It is an object of the present invention to provide a proton conductor that has good proton conductivity properties under medium temperature, non-humidified conditions, and a method of producing the proton conductor.

A proton conductor according to a first aspect of the present invention includes a composite material that is produced by mechanical mixing of an azole compound and a solid inorganic acid salt that contains an acid salt of an oxo acid.

The term composite material indicates a substance that is formed by bonding the solid inorganic acid salt with the azole compound, and is different from a simple mixture of the solid inorganic acid salt and the azole compound.

According to the first aspect, the proton conductor including the composite material, which is produced by mechanically mixing the azole compound and the solid inorganic acid salt containing the acid salt of the oxo acid, has good proton conductivity properties under medium temperature, non-humidified conditions. Therefore, the proton conductor including the composite material can be used for an electrolyte in a fuel cell that operates under medium temperature, non-humidified conditions.

It is not necessary for the proton conductor to be doped with a large amount of phosphoric acid to secure the necessary proton conductivity as is the case with the electrolyte membrane in which PBI is doped with phosphoric acid. Accordingly, it is possible to avoid the situation where a large amount of phosphoric acid seeps out in a case where the fuel cell is used for a long time, making it possible to prevent peripheral members from being corroded.

Furthermore, since the proton conductor can be used as solid electrolyte, liquid leakage may not occur as is the case where the ionic liquid is used. Thus, contamination due to electrolyte leakage in a case where proton conductor is used in the fuel cell can be reduced.

Additionally, in the first aspect, the acid salt may be a salt in which an acidic group of the oxo acid is bonded to one of an alkaline metal and an ammonium ion by an ionic bond.

A proton of the azole compound may thus be replaced with one of the alkaline metal and the ammonium ion by the energy imparted by the mechanical mixing. In addition, a hydrogen bond network may be formed between an anion of the oxo acid and the azole compound. Since the alkaline metal and the ammonium ion are monovalent cations, the alkaline metal and the ammonium ion may be easily replaced with protons. Therefore, due to the behavior of the alkaline metal or the ammonium ion and the three-dimensional hydrogen bond network formed between the oxo acid anion and the azole compound, the proton conductivity properties, or in other words, the ease of proton transport in the composite material, can be improved.

Additionally, in the first aspect, a mole ratio of the solid inorganic acid salt in relation to the azole compound may be one or more.

It is thus possible to give the formed composite material a structure that has good proton conductivity properties. Therefore, the conductivity properties of the proton conductor can be improved at low temperature, which is lower than the medium temperature region. As a result, in a case where the proton conductor is applied as an electrolyte used in a fuel cell, electric power generation can be started at an early stage after starting operation. In other words, the time that has to be waited for actual power generation after starting operation can be shortened, making it possible to achieve quick power generation.

A proton conductor according to a second aspect of the present invention includes a composite material that contains an azole compound and a solid inorganic acid salt that contains an acid salt of an oxo acid.

It is not necessary for the proton conductor to be doped with a large amount of phosphoric acid to secure the necessary proton conductivity as is the case with the electrolyte membrane in which PBI is doped with phosphoric acid. Accordingly, it is possible to avoid the situation where a large amount of phosphoric acid seeps out in a case where the fuel cell is used for a long time, making it possible to prevent peripheral members from being corroded.

Furthermore, since the proton conductor can be used as solid electrolyte, liquid leakage may not occur as is the case where the ionic liquid is used. Thus, contamination due to electrolyte leakage when the proton conductor is used in the fuel cell can be reduced.

In addition, the conductivity properties of the proton conductor can be improved at low temperature, which is lower than the medium temperature region. As a result, in a case where the proton conductor is applied as an electrolyte used in a fuel cell, electric power generation can be started at an early stage after starting operation. In other words, the time that has to be waited for actual power generation after starting operation can be shortened, making it possible to achieve quick power generation.

Additionally, in the first aspect, a mole ratio of the solid inorganic acid salt in relation to the azole compound may be one or more.

It is thus possible give the composite material a structure that has good proton conductivity properties, making it possible to exhibit good proton conductivity properties even under medium temperature, non-humidified conditions. Accordingly, the proton conductor can be applied to an electrolyte used in a fuel cell that operates under medium temperature, non-humidified conditions.

Additionally, in the second aspect, the acid salt may be a salt in which an acidic group of the oxo acid is bonded to one of an alkaline metal and an ammonium ion by an ionic bond.

Thus it is possible to obtain a composite material that has a structure in which a proton of the azole compound is replaced with one of the alkaline metal and the ammonium ion that are monovalent cations. Therefore, due to the behavior of the alkaline metal or the ammonium ion, the proton conductivity properties, or in other words, the ease of proton transport in the composite material can be improved.

Additionally, in the first aspect and the second aspect, the azole compound may contain two or more nitrogen atoms in a heterocyclic 5-membered ring.

It is possible to increase in the azole compound the number of nitrogen atoms that have an effect on the proton transport, making it possible to improve the proton conductivity properties.

Additionally, in the first aspect and the second aspect, the azole compound may be a triazole.

It is thus possible to obtain a composite material that has good proton conductivity properties. Additionally, since triazole is a general-purpose compound which can be easily obtained, a proton conductor can be produced at low cost.

Although it can be expected that the proton conductivity properties will improve in a case where there are a greater number of nitrogen atoms in the azole compound, if the azole compound is not a general-purpose compound, it may lead to an increase in the costs of production. Moreover, some types of nitrogen compounds may be explosive, so some types of nitrogen compounds may be handled with care. Consequently, some types of nitrogen compounds may be hard to handle during production. However, triazole is a nitrogen compound that is available as general-purpose compound and has a low risk of explosion. Therefore, it is possible to produce the composite material at low cost and it is easier to control materials and processes.

A method of producing a proton conductor according to a third aspect of the present invention includes a mixing process of producing, by mechanical mixing of an azole compound and a solid inorganic acid salt that contains an acid salt of an oxo acid, a composite material containing the azole compound and the solid inorganic acid salt.

According to the third aspect, the composite material obtained by the mixing process has a new structure that is different from either the solid inorganic acid salt or the azole compound. Therefore, the new composite material may have higher proton conductivity properties under medium temperature, non-humidified conditions than any one of the solid inorganic acid salt and the azole compound. Consequently, by using the composite material that is formed, it is possible to produce a proton conductor that has good proton conductivity properties under medium temperature, non-humidified conditions.

In addition, since the composite material can be produced with a simple and easy process of mechanical mixing, the desired composite material can be produced with fewer processes than a method of producing inorganic-organic composite material such as a sol-gel method. This may result in reduction in the costs of production and achievement of good production efficiency.

Additionally, in the third aspect, the acid salt may be a salt in which an acidic group of the oxo acid is bonded to one of an alkaline metal and an ammonium ion by an ionic bond.

A proton of the azole compound may thus be replaced with one of the alkaline metal and the ammonium ion by the energy imparted by the mechanical mixing. In addition, a hydrogen bond network may be formed between an anion of the oxo acid and the azole compound. Since the alkaline metal and the ammonium ion are monovalent cations, the alkaline metal and the ammonium ion are monovalent cations may be easily replaced with protons. Therefore, due to the behavior of the alkaline metal or the ammonium ion and the three-dimensional hydrogen bond network formed between the oxo acid anion and the azole compound, the proton conductivity properties, or in other words, the ease of proton transport in the composite material, can be improved.

Additionally, in the third aspect, the mixing process may be performed by mixing the solid inorganic acid salt and azole compound, a mole ratio of the solid inorganic acid salt in relation to the azole compound being one or more.

It is thus possible to give the obtained composite material a structure that has good proton conductivity properties. Therefore, the conductivity properties of the obtained proton conductor may be improved at low temperature, which is lower than the medium temperature region. As a result, in a case where the proton conductor is applied as an electrolyte used in a fuel cell, electric power generation can be started at an early stage after starting operation. In other words, the time that has to be waited for actual power generation after starting operation can be shortened, making it possible to achieve quick power generation.

Additionally, in the third aspect, the azole compound may contain two or more nitrogen atoms in a heterocyclic 5-membered ring.

It is possible to increase in the azole compound the number of nitrogen atoms that have an effect on the proton transport, making it possible to improve the proton conductivity properties.

Additionally, in the third aspect, the azole compound may be a triazole.

It is thus possible to obtain a composite material that exhibits good proton conductivity properties and to produce a proton conductor at low cost. Although it can be expected that the proton conductivity properties will improve in a case where there are a greater number of nitrogen atoms in the azole compound, if the azole compound is not a general-purpose compound, it may lead to an increase in the costs of production. Moreover, some types of nitrogen compounds are explosive, so some types of nitrogen compounds may be hard to handle. However, triazole is a nitrogen compound that is available as general-purpose compound and has a low risk of explosion. Therefore, it is possible to produce the composite material at low cost and it is easier to control materials and processes.

Additionally, in the third aspect, the mixing process may be performed by milling processing that uses a planetary ball mill.

Thus, the mixture can be subjected to a greater impact than is possible with a normal ball mill, for example, making it possible to produce a composite material by mixing the solid inorganic acid salt and the azole compound efficiently and quickly.

### BRIEF DESCRIPTION OF DRAWINGS

FIG. 1A is a figure that shows results of measurement by Raman spectroscopy performed on composite materials produced in a first example and specimens prepared in first and second comparison examples.

FIG. 1B is a figure that shows results of measurement by Raman spectroscopy performed on the composite materials produced in the first example and the specimens prepared in the first and second comparison examples.

FIG. 2 is a figure that shows results of measurement by solid NMR performed on the composite materials produced in the first example, and the specimens prepared in the first and second comparison examples.

FIG. 3 is a figure that shows ionic conductivity of the composite materials produced in the first example and the specimens prepared in the first and second comparison examples.

FIG. 4 is a figure that shows thermogravimetric changes of the composite materials produced in the first example and the specimens prepared in the first and second comparison examples.

FIG. 5 is a figure that shows thermogravimetric changes at 120° C. of the composite materials produced in the first example and the specimens prepared in the first and second comparison examples.

FIG. 6 is a figure that shows ionic conductivity of composite materials produced in a second example and the specimens prepared in the first and second comparison examples.

FIG. 7 is a figure that shows ionic conductivity of composite materials produced in a third example and specimens prepared in the first comparison example and a third comparison example.

FIG. 8 is a figure that shows thermogravimetric changes of the composite materials produced in the third example and the specimens prepared in the first and third comparison examples.

FIG. 9 is a figure that shows ionic conductivity of composite materials produced in a fourth example and specimens prepared in the first comparison example and a fourth comparison example.

FIG. 10 is a figure that shows thermogravimetric changes of the composite materials produced in the fourth example and the specimens prepared in the first and fourth comparison examples.

FIG. 11 is a figure that shows ionic conductivity of composite materials produced in a fifth example and specimens prepared in the first comparison example and a fifth comparison example.

FIG. 12 is a figure that shows ionic conductivity of composite materials produced in a sixth example and specimens prepared in the second comparison example and a sixth comparison example.

FIG. 13 is a figure that shows ionic conductivity of composite materials produced in a seventh example and the specimens prepared in the fourth and sixth comparison examples.

FIG. 14 is a figure that shows ionic conductivity of a mixture a produced in a seventh comparison example and a mixture b produced in an eighth comparison example.

### DESCRIPTION OF EMBODIMENTS

Hereinafter, a proton conductor and a method of producing the proton conductor according to the present invention will be explained in detail.

The proton conductor according to the present invention is mainly formed by a composite material that is produced from a solid inorganic acid salt and an azole compound. The solid inorganic acid salt is a substance like an oxo acid compound or a hydrate of metallic oxide having proton conductivity properties. In the present invention, the oxo acid compound is used as the material for producing the composite material.

The oxo acid compound used in the present invention is not a normal salt but an acid salt in which a hydrogen atom remains and has an MHₙAO₄ structure, where M represents a monovalent alkaline metal or NH₄ ion. The oxo acid compound is an acid salt in which an acidic group is bonded to one of the alkaline metal and the NH₄ ion by an ionic bond. An oxo acid anion in the oxo acid compound does not necessarily indicate a state in which the oxo acid anion is separated from M, but the oxo acid anion may indicate the group of atoms in the compound. Preferably, an alkaline metal with a large ionic radius may be used. Examples of such alkaline metals with a large ionic radius include K, Cs, Rb, and the like. A is not particularly limited so long as A is an element that forms oxo acid anion (HₙAO₄⁻) with four oxygen. Examples of the elements that form the oxo acid anion include S, Se, As, P, and the like. n represents the number of hydrogen atoms.

Examples of the solid inorganic acid salts include, but are not limited to, cesium hydrogen sulfate (CsHSO₄), cesium dihydrogen phosphate (CsH₂PO₄), triammonium hydrogen disulfate ((NH₄)₃H(SO₄)₂), dicesium hydrogen sulfate dihydrogen phosphate (Cs₂(HSO₄)(H₂PO₄)), cesium pentahydrogen diphosphate (CsH₅(PO₄)₂). The solid inorganic acid salt may be an acid salt of the oxo acid itself as described above or a compound that partially contains the acid salt of the oxo acid.

An azole compound is a heterocyclic compound that contains at least one nitrogen atom in the five-membered ring. The compound is respectively called azole, diazole, triazole, and tetrazole as the number of the nitrogen atoms included in the hetero cycle increases from one to four. The azole compound according to the present invention contains the above-mentioned azole, diazole, triazole, and tetrazole as well as their derivatives.

Specifically, the azole compound may have a hydrogen atom that bonds to a nitrogen atom in the hetero cycle. Examples of the compounds include 1H-azole(pyrrole), 2H-azole(2H-pyrrole), 1,3-diazole(imidazole, refer to the formula (1) below), 1,2-diazole(pyrazole, refer to the formula (2) below), 1H-1,2,3 triazole, 1H-1,2,4 triazole (refer to the formula (3) below), 1H-tetrazole (refer to the formula (4) below) and their derivatives.

A derivative is a compound in which a hydrogen atom other than the hydrogen atom that is bonded to a nitrogen atom is replaced. In the imidazole shown in the formula (1) below, the hydrogen atoms in positions 2, 4 and 5 are replaced by other atoms or groups of atoms (radicals). In the pyrazole shown in the formula (2) below, the hydrogen atoms in positions 3, 4 and 5 are replaced by other atoms or groups of atoms (radicals). In the 1H-1,2,4 triazole shown in the formula (3) below, the hydrogen atoms in positions 3 and 5 are replaced by other atoms or groups of atoms (radicals). In the 1H-1,2,3 triazole, the hydrogen atoms in positions 4 and 5 are replaced by other atoms or groups of atoms (radicals). In the tetrazole shown in the formula (4) below, the hydrogen atom in position 5 is replaced by another atom or a group of atoms (radical). One or a plurality of hydrogen atoms may be replaced.

Examples of the substitution groups include, but are not limited to, an alkyl group, an ester group, an amino group, a hydroxyl group, a carboxyl group, an acyl group, a phenyl group, a halogen, and the like. Moreover, the substitution group may be a compound in which rings are fused such as benzimidazole shown in the formula (5) below. In addition, the structure may be a dimer structure like 5,5′ bistetrazole, for example.

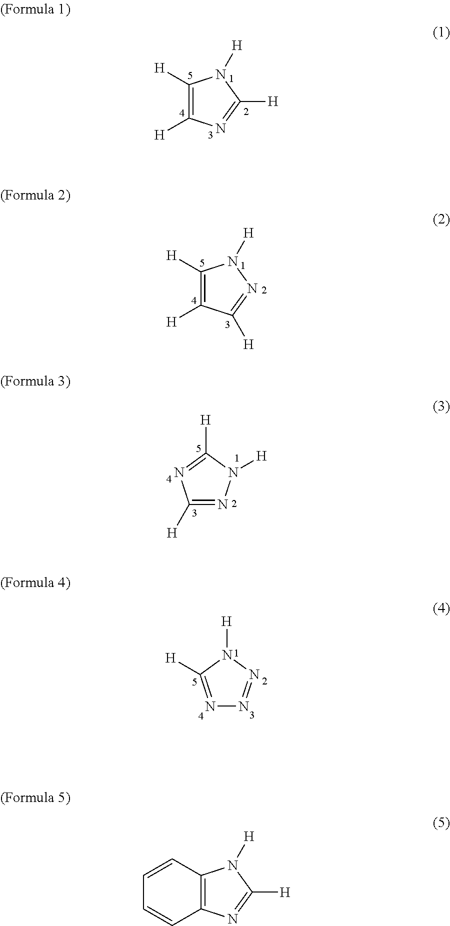 [SMILES: c1c[nH]cn1 ; c1cn[nH]c1 ; c1nc[nH]n1 ; c1nnn[nH]1 ; c1ccc2[nH]cnc2c1]

The derivative may be an analog that includes an azole structure. Examples of the analogs include a losartan and candesartan, and the like, which have a tetrazole ring.

In the present invention, a compound which is solid at room temperature may be preferably used among azole compounds. A compound that has two or more nitrogen atoms in a heterocyclic 5-membered ring may be preferably used. Examples of the azole compounds include imidazole, 1H-1,2,3 triazole, 1H-1,2,4 triazole, 1H-tetrazole, benzimidazole and, the like.

The proton conductor according to the present invention is produced by mixing the above-mentioned solid inorganic acid salt and azole compound to form a composite material. One solid inorganic acid salt and one azole compound may be mixed to produce a composite material. A plurality of solid inorganic acid salts and a plurality of azole compounds may be mixed. In addition, the obtained composite material may be used by itself to produce a proton conductor. A plurality of types of the obtained composite material may be mixed to produce a proton conductor.

The proton conductor is produced by mixing the solid inorganic acid salt and the azole compound to form a composite material, and has a new structure that is different from that of either the solid inorganic acid salt or the azole compound. The proton conductor may have good proton conductivity properties in a medium temperature region. Moreover, the proton conductivity properties may improve at low temperatures of 100° C. or less as compared to the solid inorganic acid salt or azole compound alone. Furthermore, in a case where the solid inorganic acid salt is deliquescent, the deliquescency can be reduced by mixing the solid inorganic acid salt with the azole compound to form a composite material. This makes it possible to improve quality consistency and ease of handling. Examples of the deliquescent solid inorganic acid salts include a cesium hydrogen sulfate and the like. In addition, because the proton conductor stabilizes counter ions and restricts their movement easily, it is possible to improve the proton transport number. Examples of the counter ions include a solid inorganic acid anion and an azole anion.

In the proton conductor according to the present invention, any mole ratio of the solid inorganic acid salt and the azole compound can be selected as desired. Hereinafter, the mole ratio of the solid inorganic acid salt and the azole compound is the mole ratio (X:Y) of the two materials. In an embodiment and the examples, the mole ratio of the solid inorganic acid salt and the azole compound is indicated such that the sum of the two mole ratios is 100, thus clarifying the proportion of the moles of the two materials. In a case where only the mole ratio of one material is indicated, the mole ratio of the other material is unambiguously determined. For example, when the mole ratio of one material is 20, the mole ratio of the other material will be 80. It is preferable for the mole ratio of the solid inorganic acid salt and the azole compound to be in a range from 50:50 to 90:10. It is more preferable for the mole ratio of the solid inorganic acid salt to be less than 90. In a case where the solid inorganic acid salt is a cesium hydrogen sulfate, it is preferable for the mole ratio of the solid inorganic acid salt and the azole compound to be in a range from 70:30 to 90:10, or more preferably, 80:20. When the mole ratio of the solid inorganic acid salt is indicated as 1 or more in relation to the azole compound, it means that the mole ratio of the solid inorganic acid salt is 50 or more in the present embodiments and examples.

In a case where the mole ratio of the solid inorganic acid salt is greater than a 50:50 mole ratio of the solid inorganic acid salt and the azole compound, the proton conductivity properties tend to improve at low temperatures of 100° C. or less. Meanwhile, in a case where the mole ratio of the solid inorganic acid salt and the azole compound is 90:10, the proton conductivity properties tend to decrease compared to a case in which the mole ratio of the solid inorganic acid salt is in a predetermined range that is not more than 90. Therefore, it is possible to easily produce a composite material that can be a good proton conductor by setting the mole ratio of the solid inorganic acid salt and the azole compound to be between 50:50 and 90:10.

The proton conductor according to the present invention may be produced by mechanical mixing that will be described below. In this case, the composite material obtained from the solid inorganic acid salt and the azole compound may be produced by mechanical alloying or mechanical milling In a case where a composite material of the solid inorganic acid salt and the azole compound is obtained with the above-mentioned mole ratio, such composite material may be produced using a process other than mechanical milling. For example, techniques such as ultrasonic irradiation, shock wave irradiation, or irradiation of accelerated mass particles may be applied. It is preferable to use a milling process to produce the composite material since a comparatively inexpensive facility can be used. For the milling process, a planetary ball mill, a vibratory ball mill, a rotary ball mill, an atomizer, or the like may be used. It is preferable to use a planetary ball mill.

The proton conductor according to the present invention may be formed with an accessory component so long as the characteristics of the above-mentioned composite material are not caused to significantly deteriorate. The accessory component may not only be impurities of the solid inorganic acid salt and the azole component that are inevitably mixed materials but also additives that may be added as desired.

For an additive, it is preferable to choose a solid material that improves the proton conductivity properties under medium temperature, non-humidified conditions and a material that improves the characteristics of film formation when a proton conductor film is formed. Examples of the additives include solid inorganic acid salt other than the acid salt of oxo acid, phosphoric acid, perfluorosulfonic acid polymer, PBI, and the like.

An example of the material contained in the solid inorganic acid salt other than the acid salt of oxo acid includes heteropoly acids. To be specific, the preferable heteropoly acids include phosphotungstic acid (H₃[PW₁₂O₄₀].nH₂O), silicotungstic acid (H₄[SiW₁₂O₄₀].nH₂O), phosphomolybdic acid (H₃[PMo₁₂O₄₀].nH₂O), silicomolybdic acid (H₄[SiMo₁₂O₄₀].nH₂O), and the like.

Moreover, the proton conductor according to the present invention is in a solid powder state, so the proton conductor can be formed into a solid electrolyte by being stamped into shape as pellets. In addition, the proton conductor may be dispersed on a matrix resin to produce a film as a solid electrolyte. For the matrix resin, for example, PBI and sulfonate polyether ether keton may be used because their strength and thermal stability under medium temperature, non-humidified conditions have been confirmed. As the weight ratio of the proton conductor increases in relation to the matrix resin, the electro-chemical performance may be advantageously improved. However, mechanical properties such as flexibility and the like may diminish. Therefore, the mix ratio of the matrix resin and the proton conductor may be appropriately determined taking the balance between the electrical performance and mechanical properties into consideration.

As explained above, in the proton conductor according to the present invention, good proton conductivity properties can be achieved under medium temperature, non-humidified conditions with the composite material produced from the acid salt of the oxo acid compound and the azole compound. Furthermore, the proton conductor exhibits ionic conductivity that enables electricity to be generated easily at low temperatures of 100° C. or less. That is, the proton conductor that is obtained has good proton conductivity properties under medium temperature, non-humidified conditions is operable at low temperatures. Moreover, counter ions that transfer through the proton conductor can be reduced, making it possible to improve the proton transport number as well as enabling higher power generation efficiency to be achieved as compared to an electrolyte of ionic liquid that has been conventionally proposed.

Next, a method of producing the proton conductor according to the present invention will be explained. According to the method of producing the proton conductor of the present invention, the composite material may be produced by mechanically mixing the solid inorganic acid salt and the azole compound. Any mechanical mixing processing can be used so long as the mechanical mixing processing can apply the stress required to form the materials into the mechanical alloys. Examples of the mixing processing include a roll mill, a rod mill, a vibratory mill, a jet mill, a planetary ball mill, a rotary ball mill, a vibratory ball mill, an agitating ball mill, an atomizer, a kneader, and the like.

The solid inorganic acid salt and the azole compound may be mixed finely with mechanical energy imparted by the impact from the mixing processing. A proton of the azole compound may thus be quantitatively replaced with a monovalent cation of the solid inorganic acid salt. Then, new bonds are formed between the azole compound and the solid inorganic acid salt so that the two materials become a composite material. The formation of such bonds makes it possible to achieve high proton conductivity properties and durability that a mixture or a starting material alone cannot achieve.

In the mixing process, it is preferable to use a ball mill and more preferable to use a planetary ball mill that can apply greater stress to materials than other conventional ball mills. The solid inorganic acid salt and the azole compound can thus be mixed efficiently and reliably to produce a composite material.

In the method of producing the proton conductor according to the present invention, the solid inorganic acid salt and the azole compound which are raw materials may be mixed at any mole ratio. It is preferable for the mole ratio of the solid inorganic acid salt and the azole compound to be in a range from 50:50 to 90:10. It is more preferable for the mole ratio to be in a range from 70:30 to 90:10. Particularly, it is more preferable to be 80:20.

A mixing time may be selected that is suitable given the mixing method. In a case where a planetary ball mill is used, for example, the mixing time is preferably 10 minutes or more, and more preferably in a range from 10 minutes to 240 minutes. Even more preferably, the mixing time is in a range from 30 minutes to 240 minutes, particularly 60 minutes. In a case where a composite material is formed by the mechanical mixing, the structure of the obtained composite material may differ depending on the mixing conditions. The composite material structure influences the proton conductivity properties, so it may be difficult to produce a good proton conductor if the mixing process is performed without careful thought. However, controlling the milling process using the above-mentioned mixing time conditions makes it possible to accurately produce a proton conductor that has good proton conductivity properties.

The processes that perform the above-mentioned mixing processing pertain to those of the present invention.

In the method of producing the proton conductor according to the present invention, a refining process to refine the raw materials may be additionally performed before the above-mentioned mixing process. In a case where additives are mixed, additives may be mixed at the same time as the mixing of the solid inorganic acid salt and the azole compound. A process for mixing additives may be additionally performed before or after the mixing of the solid inorganic acid salt and the azole compound. As explained above, according to the present invention, it is possible to produce a proton conductor that has good proton conductivity properties under medium temperature, non-humidified conditions with a simple method of mechanical mixing.

In a case where the proton conductor of the present invention is used as a solid electrolyte, it can be formed using a known production method. For example, the proton conductor may be formed into a solid electrolyte by compression molding with a press. The proton conductor of the present invention may also be dispersed on a matrix resin to form a solid electrolyte membrane. For the matrix resin, for example, PBI, sulfonate polyether ether keton, sulfonate polysulfone (SPU or SPSU), and sulfonate polyimide (SPI) may be used as their strength and thermal stability under medium temperature, non-humidified conditions have been confirmed.

An example of the specific procedure for producing an electrolyte membrane will be explained. The resin and the proton conductor may be dissolved and dispersed in a casting solvent. The mix ratio of the resin and the proton conductor may be appropriately determined taking the balance between the electrical performance and mechanical properties into consideration. A stabilizing agent may be added to the resin material and the proton conductor. The solution that has been produced may be formed into a film on a glass substrate by the casting method. The membrane that is formed from the resin material and the proton conductor may thus be produced. Hereinafter, the membrane that is formed is referred to as a composite membrane.

Next, after being washed, the composite membrane may be immersed in the phosphoric acid and may be heated. The phosphoric acid may thus be doped into the interior of the composite membrane to form an electrolyte membrane. The amount of phosphoric acid doped can be regulated by varying the time for which the composite membrane is immersed in the phosphoric acid.

In the electrolyte membrane that is formed, the phosphoric acid that has been doped may contribute to proton conduction. The fuel cell that uses the electrolyte membrane may not need to be humidified. The electrolyte membrane can therefore be used in a fuel cell which operates under medium temperature, non-humidified conditions. Furthermore, within the electrolyte membrane, the proton conductor of the present invention may contribute to proton conduction along with the phosphoric acid. The electrolyte membrane therefore may exhibit high proton conductivity properties, even in a case where the amount of phosphoric acid doped is small. Moreover, the electrolyte membrane can inhibit the amount of phosphoric acid added, making it possible to reduce the occurrence of corrosion caused by the phosphoric acid.

Phosphoric acid is most preferable as the doping substance. However, the composite membrane may be doped with an electron-accepting substance that can act in both acidic and basic conditions such as sulfuric acid or the like, for example.

### FIRST EXAMPLE

Next, the present invention will be explained in greater detail based on the examples. However, the invention is not limited to those examples. Any triazole that is used in the examples and comparison examples that are described below is 1H-1,2,4 triazole. Therefore, the triazole described in the examples and comparison examples indicates 1H-1,2,4 triazole. The measurement methods used in the examples and comparison examples are described below.

(a) Ionic Conductivity Measurements

A press forming machine (P-16B, RIKEN Corporation) was used to produce measurement samples in pellet shape with a diameter of 12 mm by pressing a measurement object for one minute at 60 MPa. An electro-chemical measurement system (SI 1260, Solartron) was used to measure the ionic conductivity for each of the prepared measurement samples. The measurement was performed in the range from 60° C. to 160° C. (rate of temperature increase: 5° C./min.) under conditions of no humidification. Data were collected using a dedicated software (Z-plot, Scribner Associates). The ionic conductivity was measured to evaluate the proton conductivity properties. High ionic conductivity indicates high proton conductivity properties.

(b) Measurements by TGA

A TGA instrument (Rigaku Thermo Plus TG 8120, Rigaku Corporation) was used to measure the thermogravimetric changes in a case where the atmospheric temperature was raised from room temperature to 500° C. in increments of 10° C. every minute in an air atmosphere. In addition, the thermogravimetric change was also measured using the TGA instrument when the temperature was kept at 120° C. in an air atmosphere.

(c) Measurements by Raman Spectroscopy

A laser Raman spectrophotometer (NRS-3100, JASCO Corporation) was used to measure the spectrum of Raman-scattered light using Fourier-transform Raman spectroscopy (FT-Raman). The measurement was performed under conditions of CCD detector temperature of −50° C., the measurement wave number of 400 to 4000 cm⁻¹, 2 seconds of exposure time to a light source, and cumulative total repetition of 16 times.

(d) Measurements by Nuclear Magnetic Resonance (NMR)

An NMR measuring instrument (UNITY-400P, Varian Technologies Japan, Ltd.) was used to evaluate the atomic geometry by performing the solid NMR measurements using nuclear magnetic resonance (NMR). The solid NMR measurement was performed by packing the samples into a rotor with a diameter of 7 mm at a revolution speed of 5000 rpm in a nitrogen atmosphere. The samples were dried at 120° C. in a vacuum atmosphere.

### FIRST EXAMPLE

Cesium hydrogen sulfate (Soekawa Chemical Co., Ltd.) was added to triazole (1H-1,2,4 triazole, Tokyo Chemical Industry Co., Ltd.) such that the mole ratios were 90:10, 80:20, 70:30, 60:40, 50:50, 40:60, 30:70, 20:80, and 10:90. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium hydrogen sulfate-triazole composite materials that corresponded to each of the mix ratios were produced. The produced composite material is hereinafter referred to as xCHS(100-x)Tz composite material, where x represents the mole ratio of the cesium hydrogen sulfate.

### SECOND EXAMPLE

Cesium hydrogen sulfate (Soekawa Chemical Co., Ltd.) was added to triazole (1H-1,2,4 triazole, Tokyo Chemical Industry Co., Ltd.) such that the mole ratio was 80:20. This material was put into a planetary ball mill (planetary ball mill (Fritsch Pulverisette 7), Fritsch Japan Co., Ltd.) to perform the milling process at a revolution speed of 720 rpm in a nitrogen atmosphere. The mixing time was set to 10 minutes, 30 minutes, 60 minutes, 120 minutes, and 240 minutes. Then, the material taken out from the planetary ball mill was dried for 10 hours in a vacuum oven at 100° C., so that white and solid cesium hydrogen sulfate-triazole composite materials that corresponded to each of the mixing time were produced.

### THIRD EXAMPLE

Cesium hydrogen sulfate (Soekawa Chemical Co., Ltd.) was added to imidazole (Tokyo Chemical Industry Co., Ltd.) such that the mole ratios were 90:10, 80:20, 70:30, 50:50, 40:60, 30:70, 20:80, and 10:90. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium hydrogen sulfate-imidazole composite materials that corresponded to each of the mix ratios were produced. The produced composite material is hereinafter referred to as xCHS(100-x)Iz composite material, where x represents the mole ratio of the cesium hydrogen sulfate.

### FORTH EXAMPLE

Cesium hydrogen sulfate (Soekawa Chemical Co., Ltd.) was added to benzimidazole (Tokyo Chemical Industry Co., Ltd.) such that the mole ratios were 90:10, 80:20, 70:30, 60:40, 50:50, 40:60, 30:70, 20:80, and 10:90. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium hydrogen sulfate-benzimidazole composite materials that corresponded to each of the mix ratios were produced. The produced composite material is hereinafter referred to as xCHS(100-x)Bz composite material, where x represents the mole ratio of the cesium hydrogen sulfate.

### FIFTH EXAMPLE

Cesium hydrogen sulfate (Soekawa Chemical Co., Ltd.) was added to tetrazole (1H-tetrazole, Tokyo Chemical Industry Co., Ltd.) such that the mole ratios were 90:10, 80:20, 70:30, and 60:40. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium hydrogen sulfate-tetrazole composite materials that corresponded to each of the mix ratios were produced. The produced composite material is hereinafter referred to as xCHS(100-x)Tez composite material, where x represents the mole ratio of the cesium hydrogen sulfate.

### SIXTH EXAMPLE

Cesium dihydrogen phosphate (Mitsuwa Chemicals Co., Ltd.) was added to triazole (1H-1,2,4 triazole, Tokyo Chemical Industry Co., Ltd.) such that the mole ratios were 90:10, 80:20, 70:30, 60:40, and 50:50. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium dihydrogen phosphate-triazole composite materials that corresponded to each of the mix ratios were produced. The produced composite material is hereinafter referred to as xCDP(100-x)Tz composite material, where x represents the mole ratio of the cesium dihydrogen phosphate.

### SEVENTH EXAMPLE

Cesium dihydrogen phosphate (Mitsuwa Chemicals Co., Ltd.) was added to benzimidazole (Tokyo Chemical Industry Co., Ltd.) such that the mole ratios were 90:10, 80:20, 70:30, 60:40 and 50:50. Each of them was put into a planetary ball mill (planetary ball mill (Fritsch Pulverisette 7), Fritsch Japan Co., Ltd.) to perform the milling process at a revolution speed of 720 rpm for 60 minutes in a nitrogen atmosphere. Then, the material taken out from the planetary ball mill was dried for 10 hours in a vacuum oven at 100° C., so that white and solid cesium dihydrogen phosphate-benzimidazole composite materials that corresponded to each of the mix ratios were produced. The produced composite material is hereinafter referred to as xCDP(100-x)Bz composite material, where x represents the mole ratio of the cesium dihydrogen phosphate.

### FIRST TO SIXTH COMPARISON EXAMPLES

Each of the materials that are described below was grinded into a fine powder in an agate mortar to prepare specimens of first to sixth comparison examples. For the first comparison example, cesium hydrogen sulfate (Soekawa Chemical Co., Ltd.) was used. For the second comparison example, triazole (1H-1,2,4 triazole, Tokyo Chemical Industry Co., Ltd.) was used. For the third comparison example, imidazole (Tokyo Chemical Industry Co., Ltd.) was used. For the forth comparison example, benzimidazole (Tokyo Chemical Industry Co., Ltd.) was used. For the fifth comparison example, tetrazole (Tokyo Chemical Industry Co., Ltd.) was used. For the sixth comparison example, cesium dihydrogen phosphate (Mitsuwa Chemicals Co., Ltd.) was used. The specimens prepared for the first to sixth comparison examples are merely raw materials, thus the following explanation will be given using the names of the raw materials as appropriate to make the explanation easier to understand.

### SEVENTH AND EIGHTH COMPARISON EXAMPLES

Cesium hydrogen sulfate (Soekawa Chemical Co., Ltd.) was added to triazole (1H-1,2,4 triazole, Tokyo Chemical Industry Co., Ltd.) such that the mole ratio was 80:20 and was then mixed uniformly in a mortar to prepare mixture a as the seventh comparison example. Furthermore, the prepared mixture a was dried for 1 hour in a vacuum oven at 100° C. to produce a mixture b as the eighth comparison example.

Measurement Results

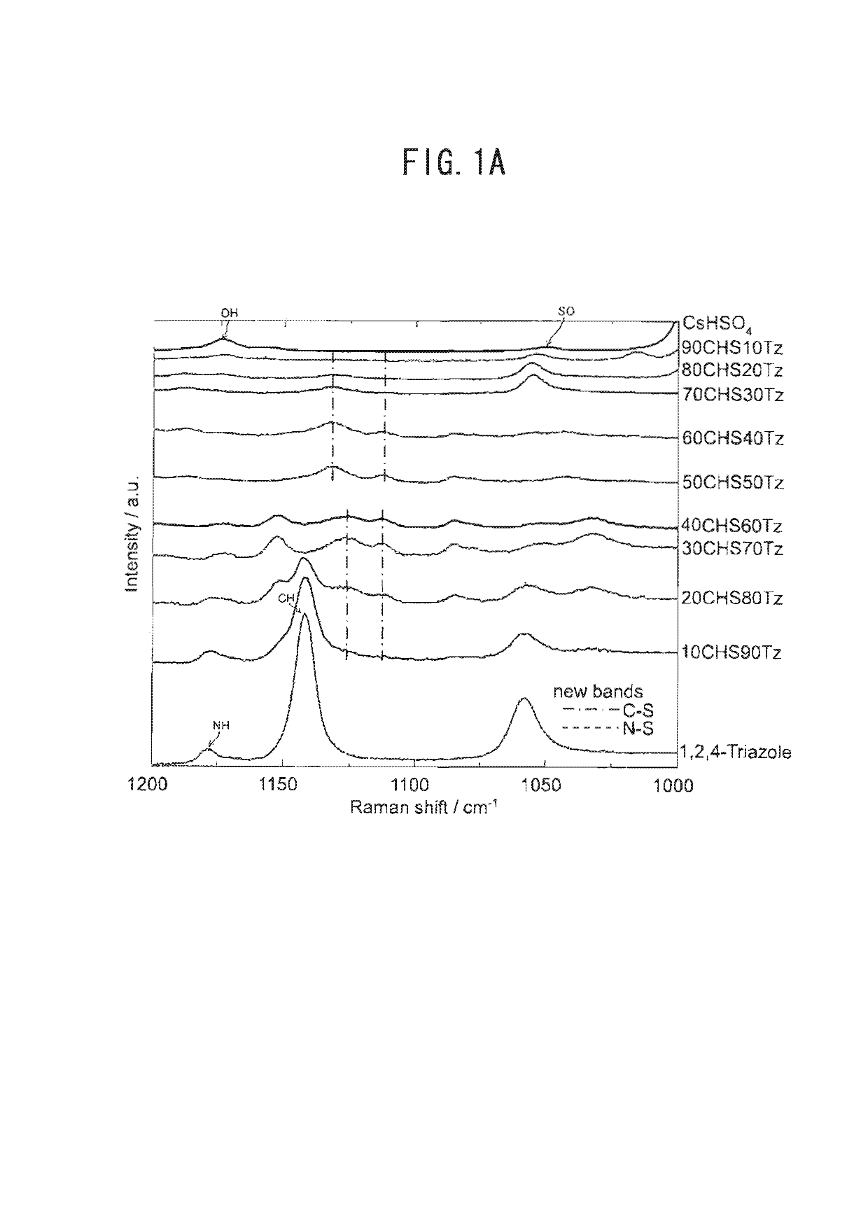

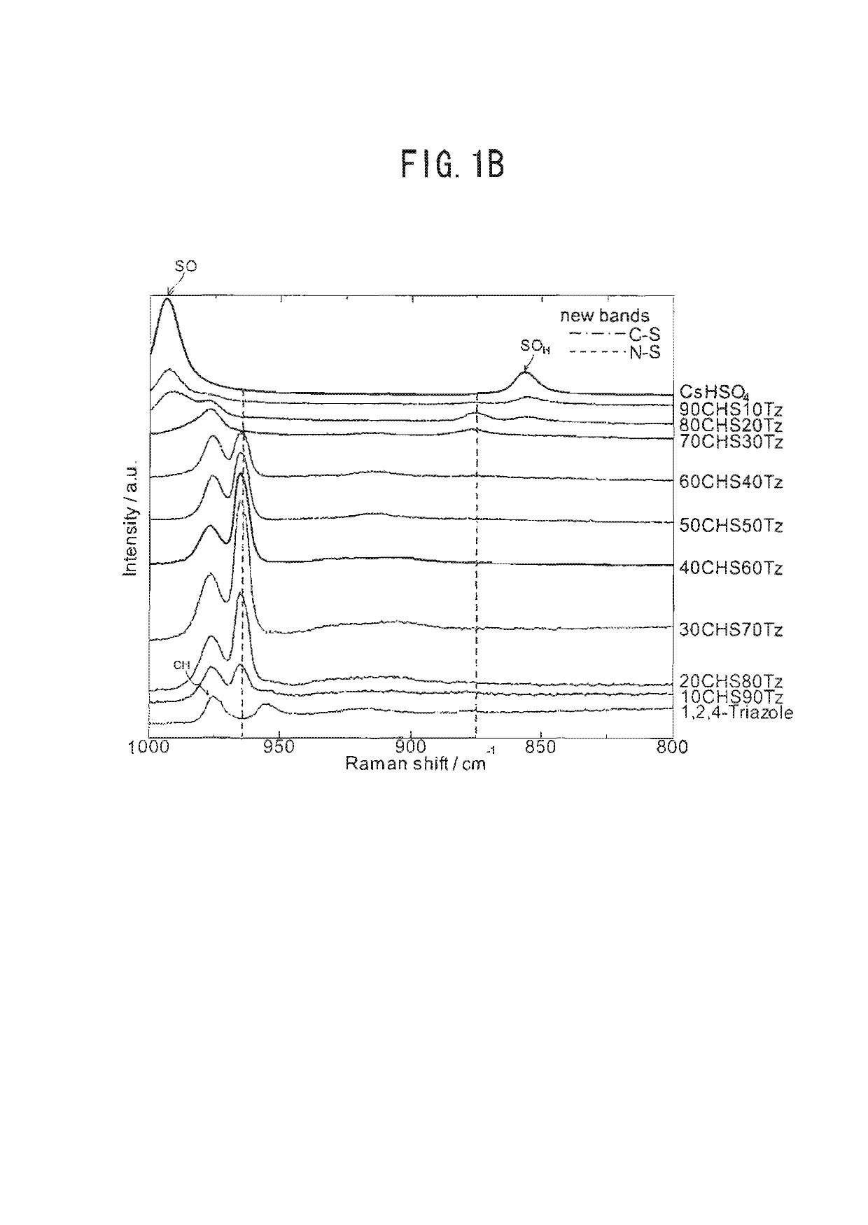

The results of the measurements by Raman spectroscopy, nuclear magnetic resonance, ionic conductivity and TGA performed on the first example and the first and second comparison examples are shown in FIGS. 1A to 5.

FIGS. 1A and 1B show the results of the measurement by Raman spectroscopy that was performed on the xCHS(100-x)Tz composite materials produced in the first example, and the specimens (cesium hydrogen sulfate, triazole) prepared in the first and second comparison examples. In FIGS. 1A and 1B, the horizontal axis indicates the wave number and the vertical axis indicates the peak intensity. The Raman spectrum was measured in a range from 800 cm⁻¹ to 1200 cm⁻¹. FIG. 1A shows the spectrum ranging from 1200 cm⁻¹ to 1000 cm⁻¹. FIG. 1B shows the spectrum ranging from 1000 cm⁻¹ to 800 cm⁻¹. Moreover, in FIGS. 1A and 1B, the measured Raman spectrums of the cesium hydrogen sulfate, the xCHS(100-x)Tz composite materials, and the triazole are shown in order beginning from the top to the bottom. Specifically, the Raman spectrums of the xCHS(100-x)Tz composite materials are shown such that x are 90, 80, 70, 60, 50, 40, 30, 20, and 10 beginning from the top in order. On the right side of each spectrum in FIGS. 1A and 1B, any one of codes, titles, material names, and chemical formulae of the composite materials corresponding to each spectrum are shown.

As can be seen in FIGS. 1A and 1B, peaks were observed in the xCHS(100-x)Tz composite materials of the first example, which were not detected in the cesium hydrogen sulfate and the triazole and that were attributed to a C—S bond and an N—S bond. The locations of the peaks that were attributed to the C—S bond are shown as chain line in FIG. 1A. The locations of the peaks that were attributed to the N—S bond are shown as broken lines in FIG. 1B. Therefore, it was shown that the composite materials produced by the mechanical mixing are not simple mixtures but have a structure that is different from either one of the triazole and the cesium hydrogen sulfate since the two materials become a composite material.

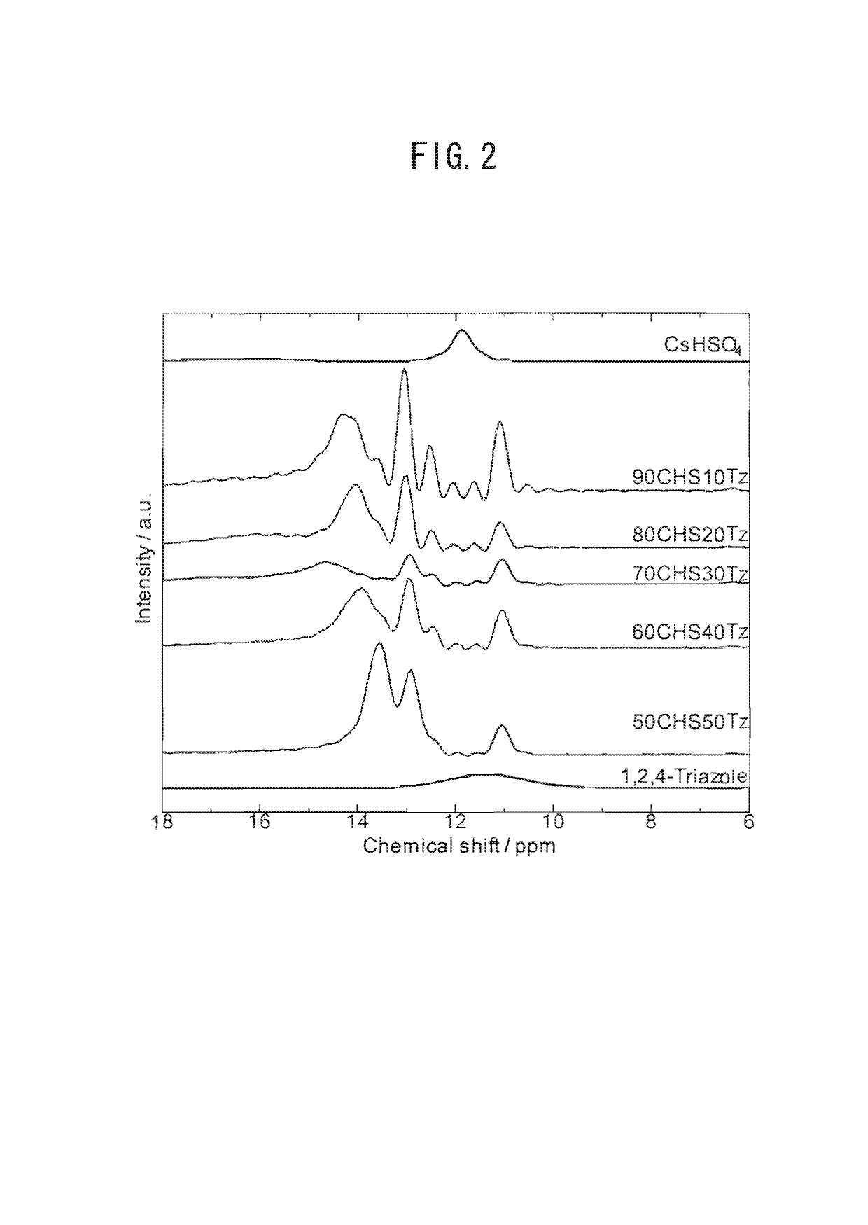

FIG. 2 shows the results of the measurement by solid NMR that was performed on the xCHS(100-x)Tz composite materials produced in the first example, and the specimens (cesium hydrogen sulfate, triazole) prepared in the first and second comparison examples. In FIG. 2, the horizontal axis indicates the chemical shift and the vertical axis indicates the peak intensity. In FIG. 2, the NMR spectrums of the cesium hydrogen sulfate, the xCHS(100-x)Tz composite materials, and the triazole are shown in order beginning from the top to the bottom. Specifically, the NMR spectrums of the xCHS(100-x)Tz composite materials are shown such that x are 90, 80, 70, 60, and 50 beginning from the top in order. On the right side of each spectrum in FIG. 2, any one of codes, titles, material names, and chemical formulae of the composite materials corresponding to each spectrum are shown.

As can be seen in FIG. 2, the NMR spectrums of the xCHS(100-x)Tz composite materials are totally different from either one of the spectrums of the triazole and the cesium hydrogen sulfate. As is the case with the results of the measurement by Raman spectroscopy shown in FIGS. 1A and 1B, it was also noted that the xCHS(100-x)Tz composite materials had a structure that was different from either one of the triazole and the cesium hydrogen sulfate since they became a composite material. In other words, it was confirmed that by mechanically mixing the acid salt of the oxo acid contained in the solid inorganic acid salt and azole compound, composite materials of both materials, which are not simple mixtures, are produced.

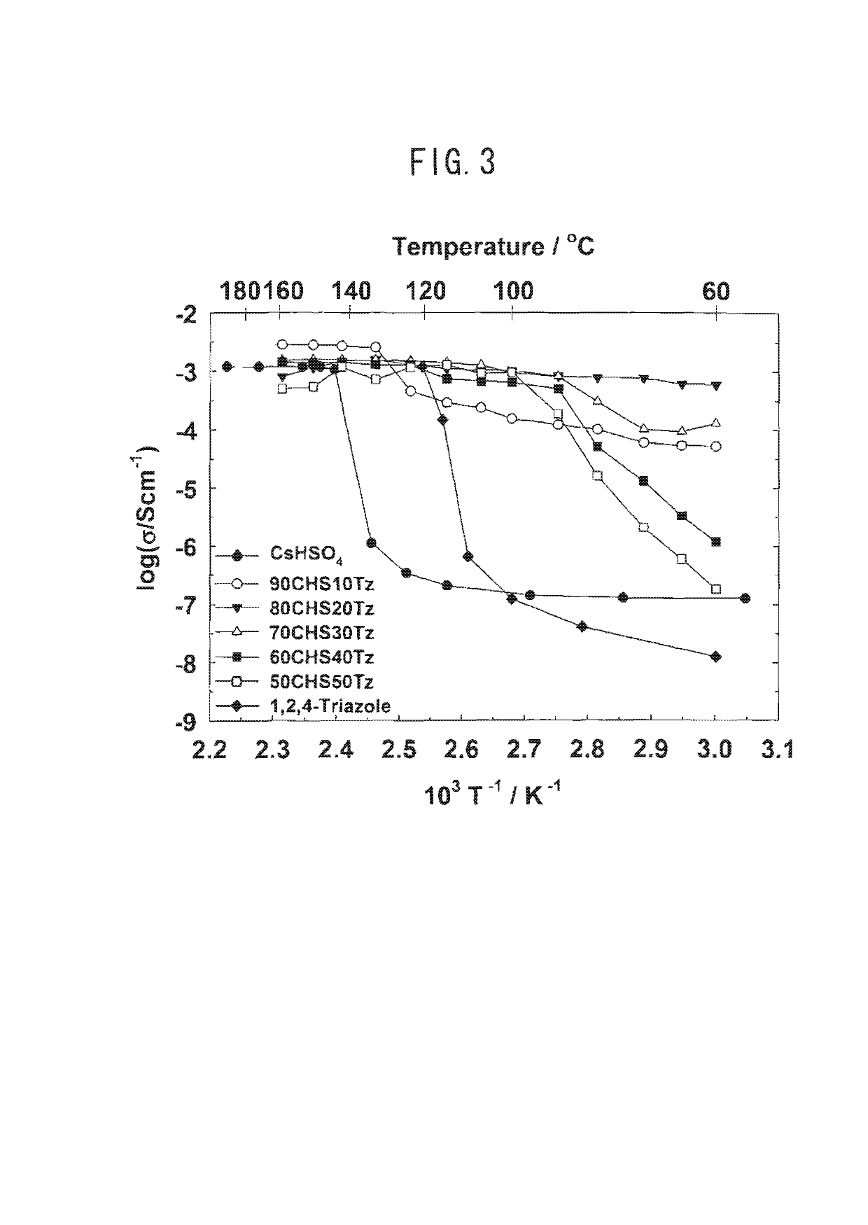

FIG. 3 shows the ionic conductivity of the xCHS(100-x)Tz composite materials produced in the first example and the specimens (cesium hydrogen sulfate, triazole) prepared in the first and second comparison examples. In FIG. 3, the horizontal axis indicates the temperature and the vertical axis indicates the conductivity. The ionic conductivity of the xCHS(100-x)Tz composite materials, the cesium hydrogen sulfate and the triazole are plotted in relation to temperature.

In FIG. 3, the plot markers shown as white circles, black downward-pointing triangles, white triangles, black squares, and white squares, respectively, indicate the ionic conductivity of the xCHS(100-x)Tz composite materials in which x are 90, 80, 70, 60, and 50. Furthermore, the black circle plot markers indicate the ionic conductivity of the cesium hydrogen sulfate and the black diamond plot markers indicate the ionic conductivity of the triazole.

As can be seen in FIG. 3, the xCHS(100-x)Tz composite materials showed high ionic conductivity of approximately 10⁻³ Scm⁻¹ over 120° C. at least in the temperature range from 120° C. to 160° C.

Moreover, in a case where the mole ratio of the cesium hydrogen sulfate was 50 or more in the xCHS(100-x)Tz composite materials, good ionic conductivity was detected even in a relatively low temperature region ranging from 60° C. to 120° C. The 70CHS30Tz composite material exhibited high ionic conductivity of minimum 10⁻⁴ Scm⁻¹ at a temperature from around 60° C. or more. Particularly, the 80CHS20Tz composite material achieved ionic conductivity of approximately 10⁻³ Scm⁻¹ in the wide temperature range from around 60° C. to 160° C. The ionic conductivity of the 90CHS10Tz composite material tended to be lower than that of 80CHS20Tz in the temperature range from 60° C. to 140° C. However, the 90CHS 10Tz composite material exhibited ionic conductivity higher than the 10⁻³ Scm⁻¹ of the cesium hydrogen sulfate prepared in the first comparison example at 140° C. or more, or at least in the temperature range from 140° C. to 160° C. Note that in a case where the mole ratio of the cesium hydrogen sulfate was 40 or less in the xCHS(100-x)Tz composite materials, which are not shown in the drawings, high ionic conductivity was not achieved particularly at 100° C. or less.

Meanwhile, the cesium hydrogen sulfate prepared in the first comparison example had high ionic conductivity of approximately 10⁻³ Scm⁻¹ at a temperature in the vicinity of 140° C., but it exhibited low ionic conductivity of less than 10⁻⁶ Scm⁻¹ below 140° C. Moreover, the triazole prepared in the second comparison example had high conductivity of approximately 10⁻³ Scm⁻¹ at 120° C., but it exhibited low ionic conductivity below 120° C.

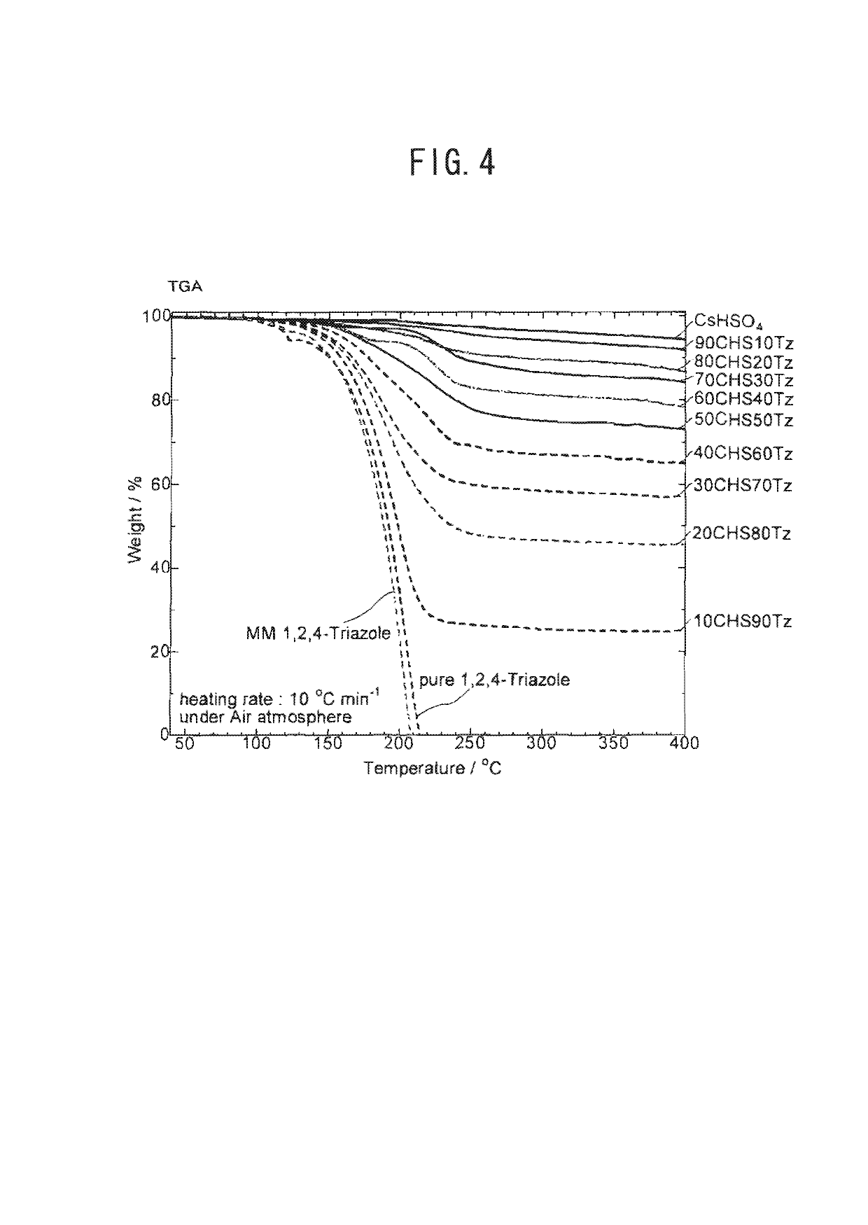

FIG. 4 shows the thermogravimetric changes of the xCHS(100-x)Tz composite materials produced in the first example and the specimens (cesium hydrogen sulfate, triazole) prepared in the first and second comparison examples. In FIG. 4, the horizontal axis indicates the temperature and the vertical axis indicates the weight fraction. The codes assigned for individual composite materials are shown next to the curves showing the thermogravimetric changes of the individual composite materials. In FIG. 4, the label “CsHSO₄” is shown next to the curve showing the thermogravimetric change of the cesium hydrogen sulfate, and the label “pure 1,2,4-Triazole” is shown next to the curve showing the thermogravimetric change of the triazol. In FIG. 4, the curve showing the thermogravimetric change of the raw triazole prepared under the same milling conditions as the first example is shown as a reference, to which the label “MM 1,2,4 Triazole” is assigned.

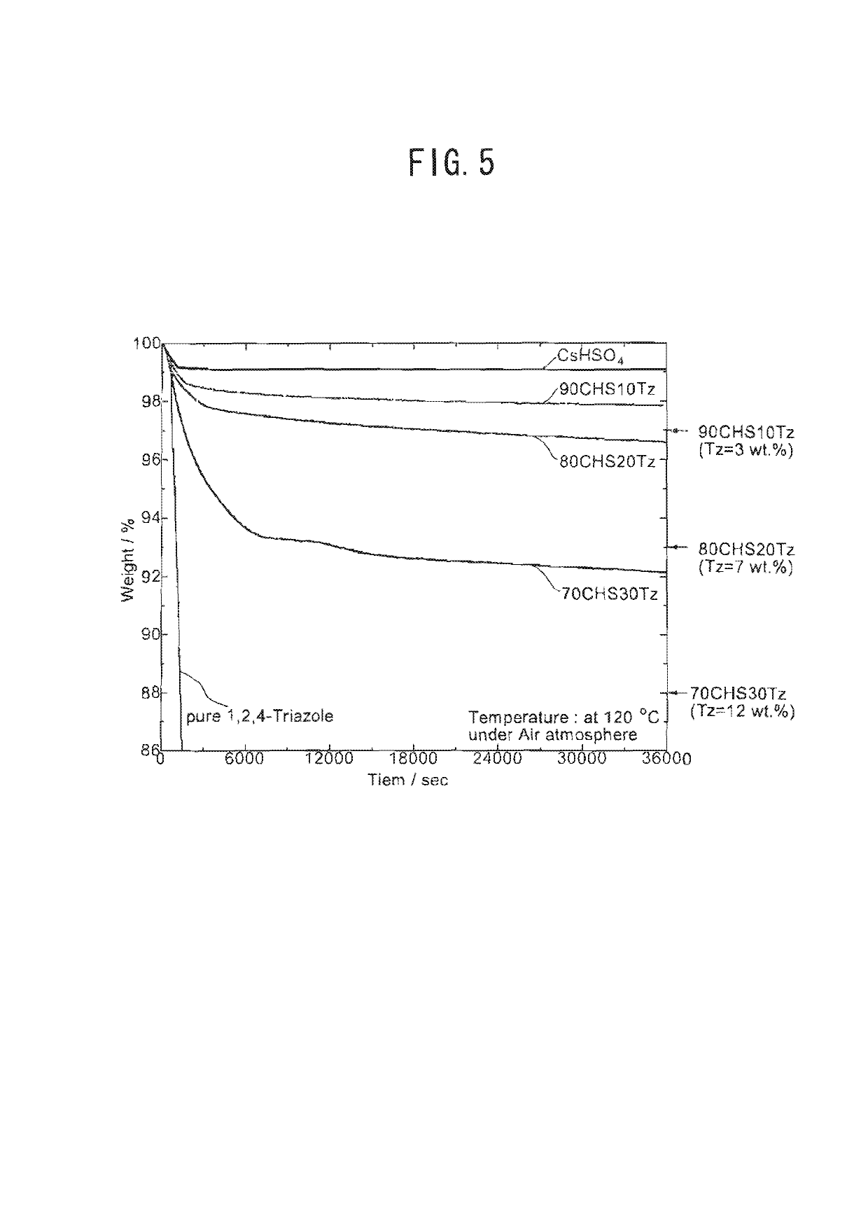

FIG. 5 shows the thermogravimetric changes at 120° C. of the xCHS(100-x)Tz composite materials produced in the first example and the specimens (cesium hydrogen sulfate, triazole) prepared in the first and second comparison examples. In FIG. 5, the thermogravimetric changes at 120° C. of the xCHS(100-x)Tz composite materials, the cesium hydrogen sulfate and triazole are shown. Specifically, the curves showing the thermogravimetric changes of the xCHS(100-x)Tz composite materials are shown such that x are 90, 80, and 70 beginning from the top in order. For the curves showing the thermogravimetric changes of each composite material and the like in FIG. 5, any one of codes, material names and chemical formulae corresponding to each curve are shown in the same way as in FIG. 4. In addition, on the right side of FIG. 5, the weight fractions of triazole contained in the composite materials are indicated with arrows. To be specific, the amount of triazole contained in the 90CHS10Tz composite material is 3 wt %, the amount of triazole contained in the 80CHS20Tz composite material is 7 wt %, and the amount of triazole contained in the 70CHS30Tz composite material is 12 wt %.

As can be seen in FIGS. 4 and 5, the thermal stability of the xCHS(100-x)Tz composite materials improved and increased compared to that of the triazole. Especially, in a case where the mole ratio of the cesium hydrogen sulfate was 50 or more in the xCHS(100-x)Tz composite materials, the thermal stability up to around 150° C. was significantly improved as shown in FIG. 4.

As shown in FIG. 5, the triazole component in the xCHS(100-x)Tz composite materials remained more than the amount of triazole even after 10 hours passed at 120° C. In other words, it was confirmed that triazole is thermally stabilized by being formed into a composite material. It has been proposed to use an azole compound as a proton conductor, but it is difficult to use for a long time under medium temperature conditions since the thermal stability may decrease at the melting point or above. However, the thermal stability of the azole compound can be improved by mixing the azole compound and the solid inorganic acid salt to produce a composite material, so it is concluded that a proton conductor that can be practically used under medium temperature, non-humidified conditions can be achieved.

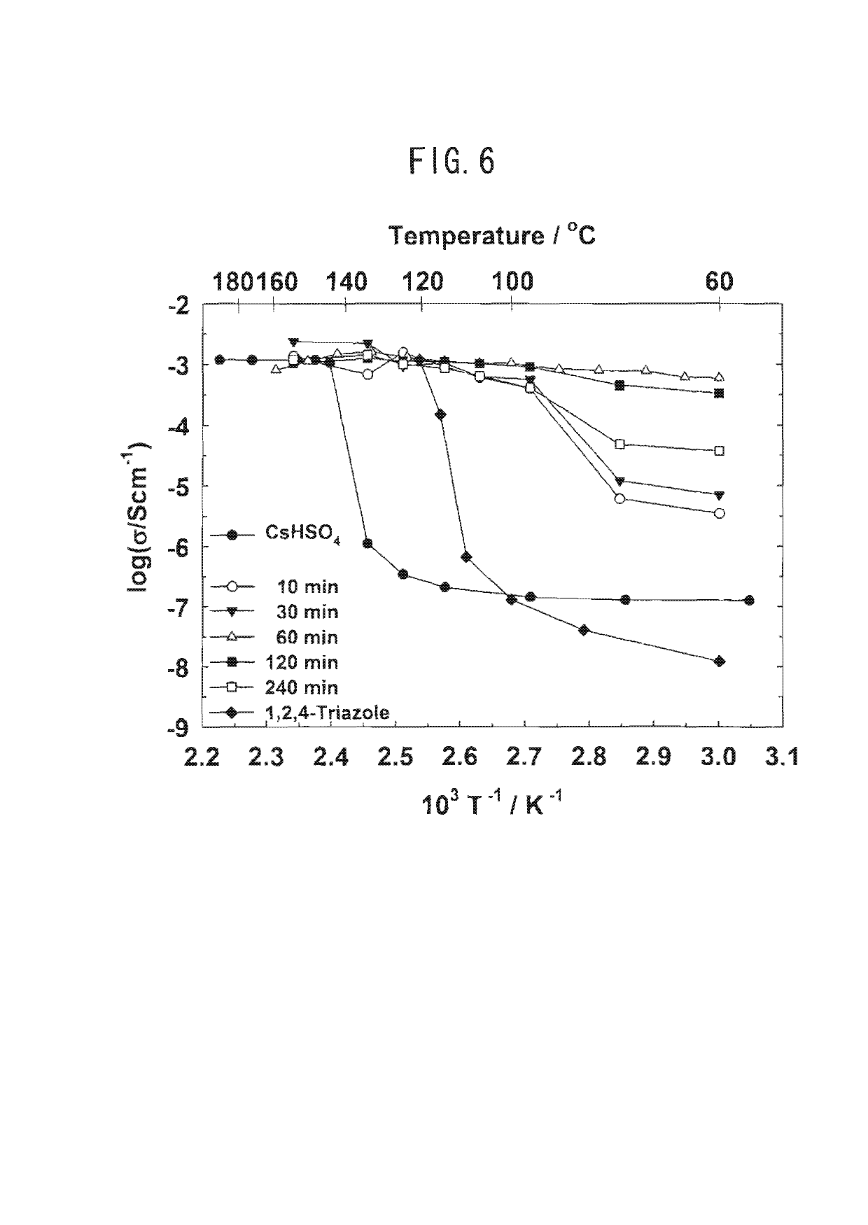

The results of the ionic conductivity measurement performed on the second example and the first and second comparison examples are shown in FIG. 6.

FIG. 6 shows the ionic conductivity of the 80CHS20Tz composite materials produced in the second example and the specimens (cesium hydrogen sulfate, triazole) prepared in the first and second comparison examples. In FIG. 6, the horizontal axis indicates the temperature and the vertical axis indicates the conductivity. The ionic conductivity of each composite material prepared in the second example, the cesium hydrogen sulfate, and the triazole are plotted in relation to temperature.

In FIG. 6, the plot markers shown as white circles, black downward-pointing triangles, white triangles, black squares, and white squares, respectively, indicate the ionic conductivity of the 80CHS20Tz composite materials that had mixing times of 10 minutes, 30 minutes, 60 minutes, 120 minutes, and 240 minutes. Furthermore, the black circle plot markers indicate the ionic conductivity of the cesium hydrogen sulfate and the black diamond plot markers indicate the ionic conductivity of the triazole.

As can be seen in FIG. 6, the 80CHS20Tz composite material obtained by milling the triazole and the cesium hydrogen sulfate for just 10 minutes exhibited ionic conductivity of 10⁻³ Scm⁻¹ at 120° C. In addition, even in a low temperature region ranging from 60° C. to 120° C., its ionic conductivity was significantly improved compared to that of the triazole and cesium hydrogen sulfate. Furthermore, the 80CHS20Tz composite material that had a mixing time of 60 minutes exhibited high ionic conductivity of 10⁻³ Scm⁻¹ in the wide temperature range from 60° C. to 160° C. Meanwhile, the ionic conductivity of the 80CHS20Tz composite material produced by mixing for 240 minutes was lower than that of the composite material produced by mixing for 120 minutes.

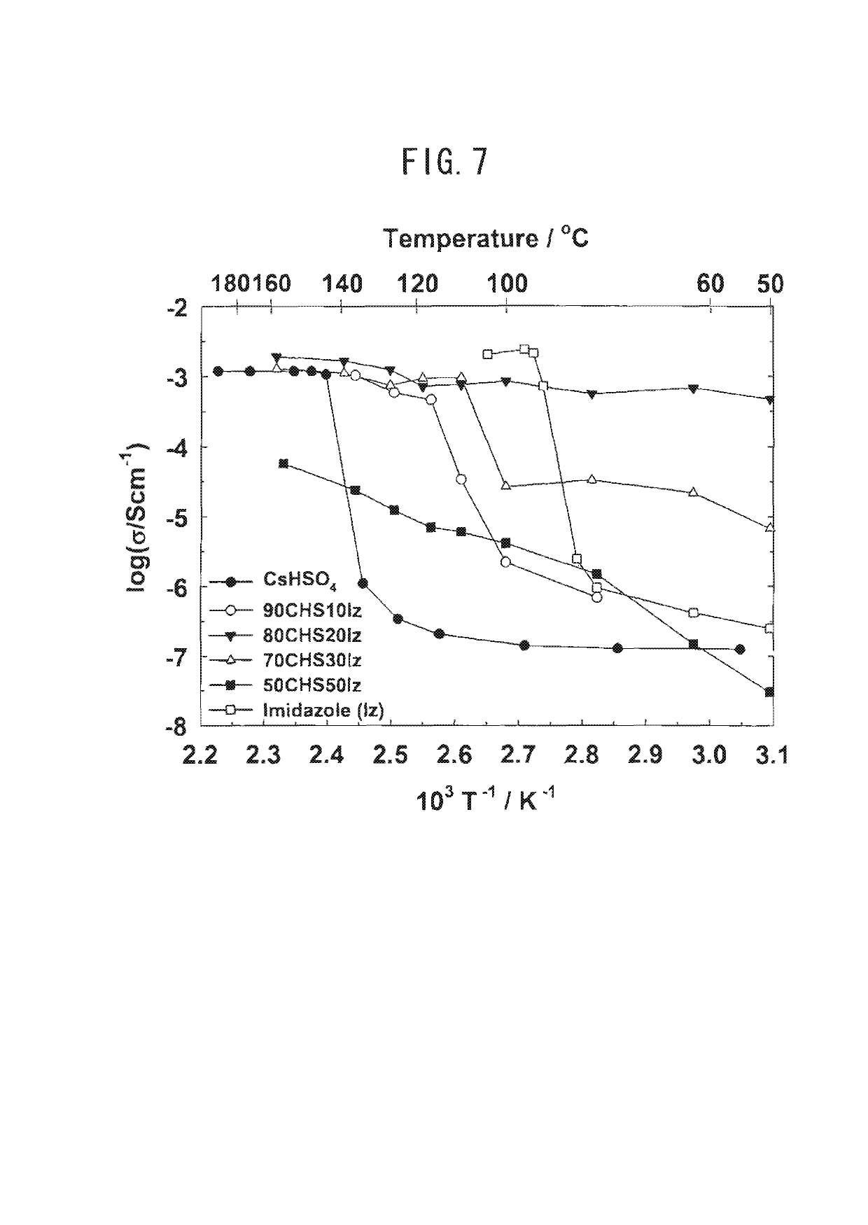

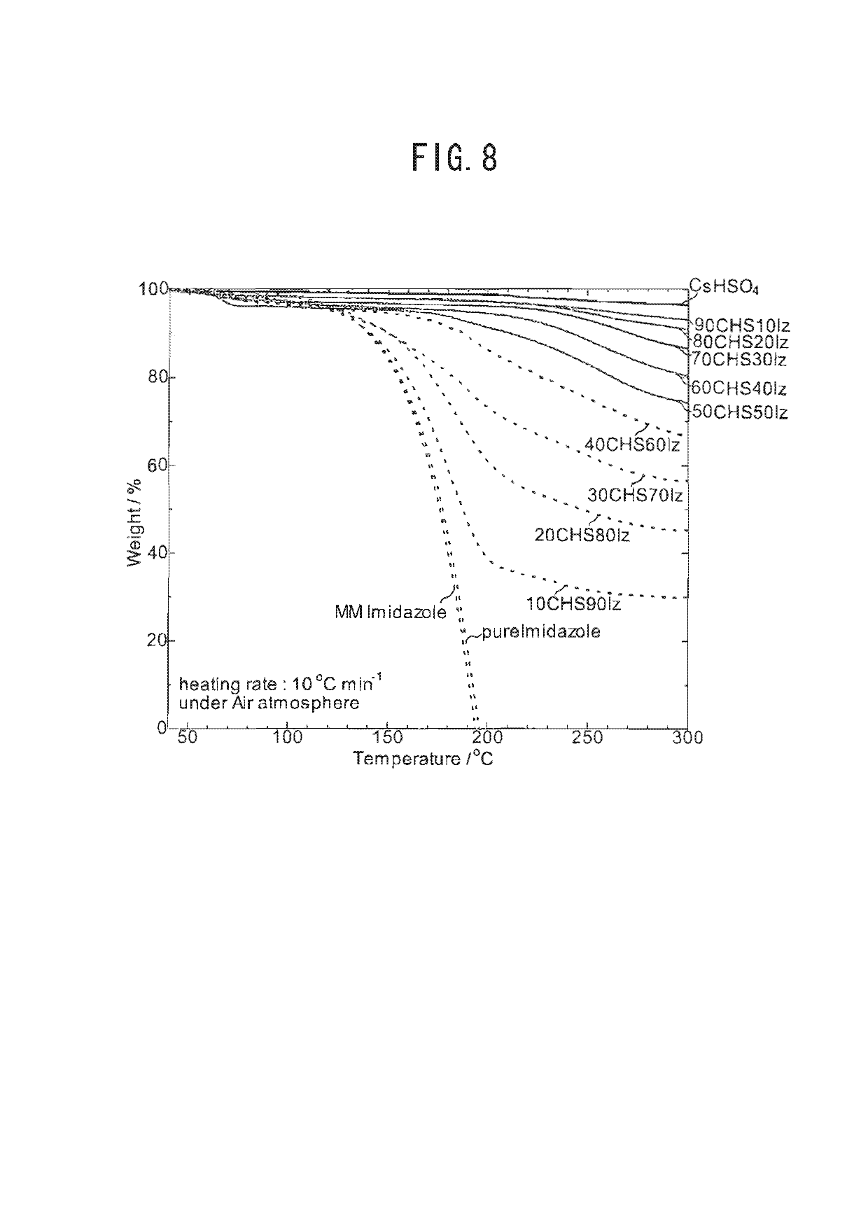

The results of the measurements of the ionic conductivity and TGA performed on the third example and the first and third comparison examples are shown in FIGS. 7 and 8.

FIG. 7 shows the ionic conductivity of the xCHS(100-x)Iz composite materials produced in the third example and the specimens (cesium hydrogen sulfate, imidazole) prepared in the first and third comparison examples. In FIG. 7, the horizontal axis indicates the temperature and the vertical axis indicates the conductivity. The ionic conductivity of the xCHS(100-x)Iz composite materials, the cesium hydrogen sulfate, and the imidazole are plotted in relation to temperature.

In FIG. 7, the plot markers shown as white circles, black downward-pointing triangles, white triangles, and black squares, respectively, indicate the ionic conductivity of the xCHS(100-x)Iz composite materials in which x are 90, 80, 70, and 50. Furthermore, the black circle plot markers indicate the ionic conductivity of the cesium hydrogen sulfate and the white square plot markers indicate the ionic conductivity of the imidazole.

FIG. 8 shows the thermogravimetric changes of the xCHS(100-x)Iz composite materials and the specimens (cesium hydrogen sulfate, imidazole) prepared in the first and third comparison examples. In FIG. 8, the horizontal axis indicates the temperature and the vertical axis indicates the weight fraction. The codes assigned for individual composite materials are shown next to the curves showing the thermogravimetric changes of the individual composite materials. In FIG. 8, the label “CsHSO₄” is shown next to the curve showing the thermogravimetric change of the cesium hydrogen sulfate, and the label “pure Imidazole” is shown next to the curve showing the thermogravimetric change of the imidazol. In FIG. 8, the curve showing the thermogravimetric change of the raw imidazole prepared under the same milling conditions as the third example is shown as a reference, to which the label “MM Imidazole” is assigned.

As can be seen in FIG. 7, the xCHS(100-x)Iz composite materials showed ionic conductivity even if the temperature was increased to over 120° C. and at least up to 160° C. Moreover, in a case where the mole ratio of the cesium hydrogen sulfate was 70 or more in the xCHS(100-x)Iz composite materials, high ionic conductivity of 10⁻³ Scm⁻¹ was detected at 120° C. The ionic conductivity of the composite materials increased approximately by 10 times to 1000 times at 50° C. compared to that of the cesium hydrogen sulfate and imidazole. Particularly, the 80CHS20Iz composite material exhibited ionic conductivity close to 10⁻³ Scm⁻¹ even at 50° C. and ionic conductivity of substantially 10⁻³ Scm⁻¹ in the wide temperature range from 50° C. to 160° C.

Furthermore, as shown in FIG. 8, the thermal stability of the xCHS(100-x)Iz composite materials improved compared to that of the imidazole. As the mole ratio of the cesium hydrogen sulfate increased in the composite materials, weight reduction became slower. Particularly, in a case where the mole ratio of the cesium hydrogen sulfate was 50 or more in the the xCHS(100-x)Iz composite materials, it was confirmed that thermal stability is significantly improved within the temperature range from 100° C. to 200° C., which is the temperature range where a medium temperature dry fuel cell is operated.

Conversely, imidazole became thermally unstable over 100° C. and its weight reduced rapidly from the vicinity of 150° C. Therefore, as shown in FIG. 7, although the imidazole shows good ionic conductivity of 10⁻³ Scm⁻¹ or more at 100° C. when the temperature is at melting point or more, it was indicated that its function as an ion conductor may be lost before the temperature reaches 120° C. In a case where the mole ratio of a cesium was 40 or less in the xCHS(100-x)Iz composite materials, high ionic conductivity was not achieved particularly at 100° C. or less.

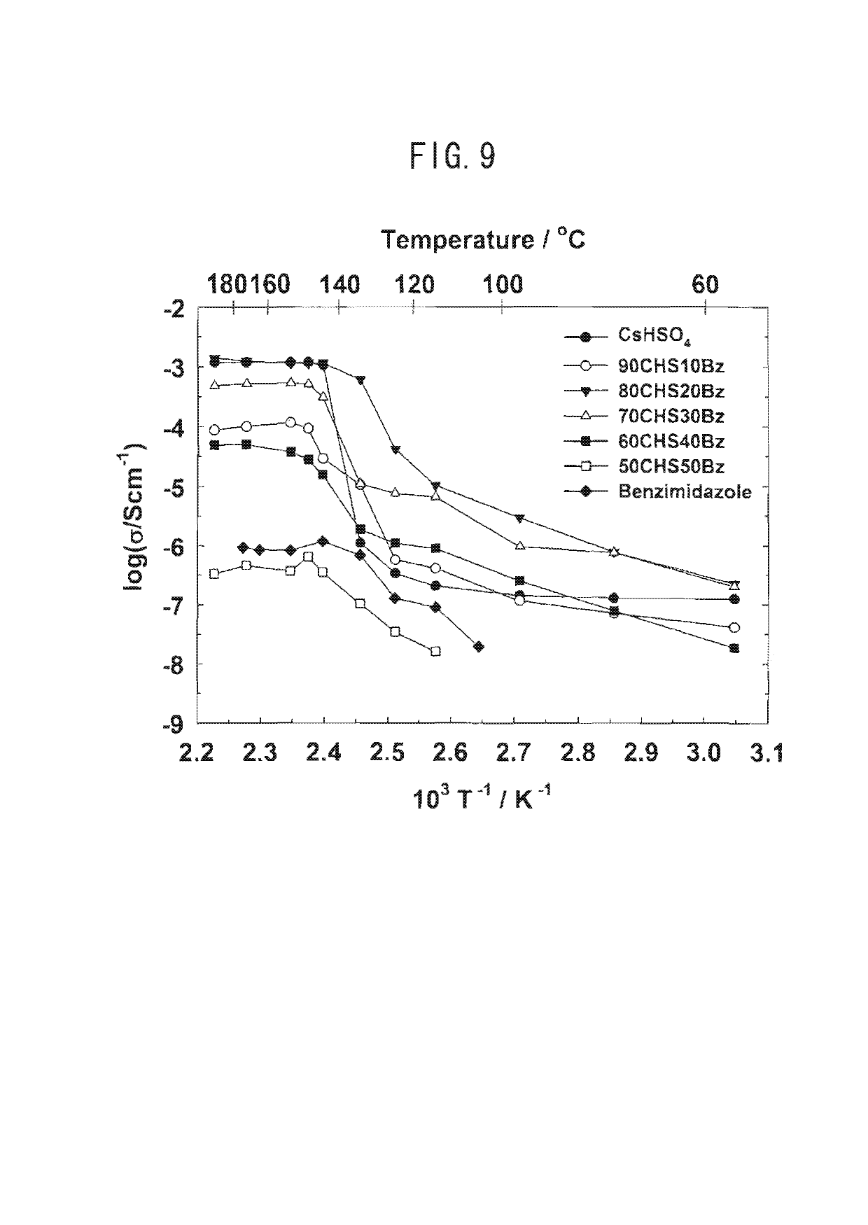

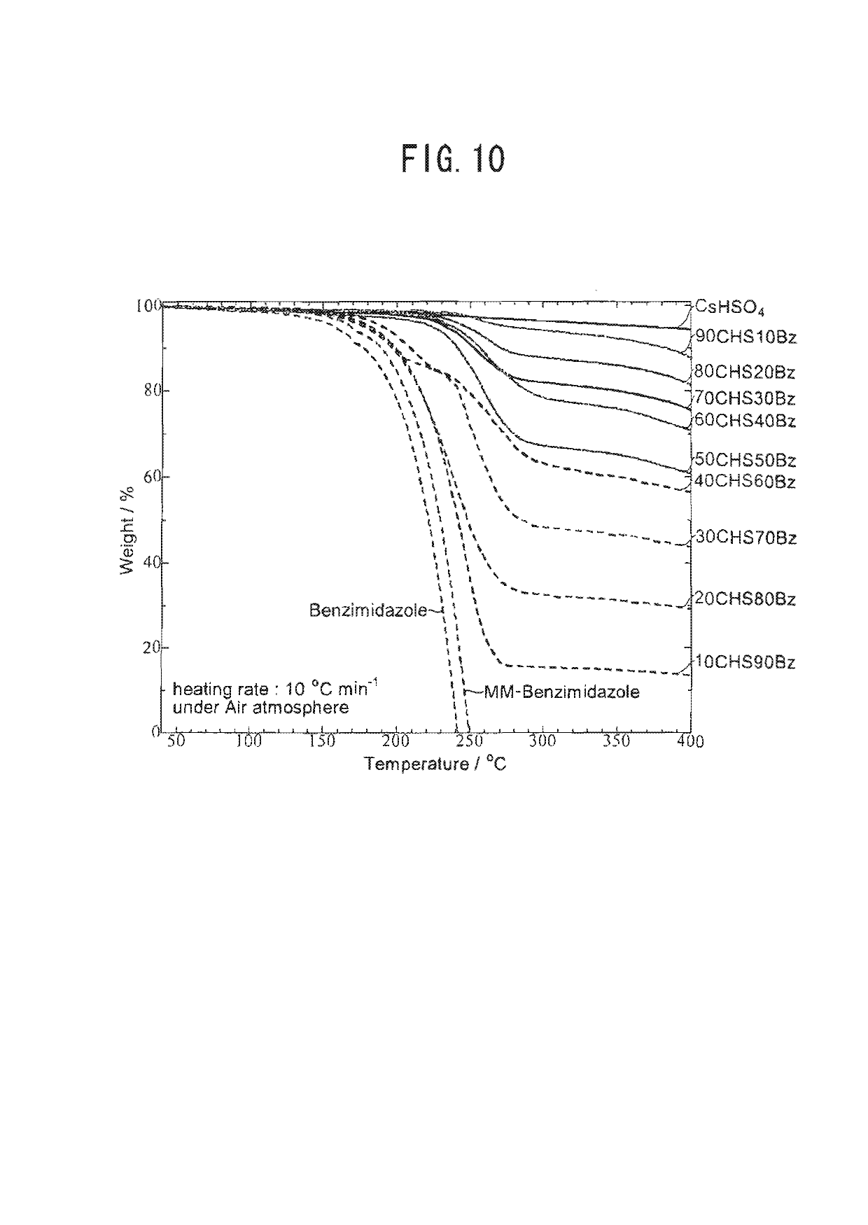

The results of the measurements of the ionic conductivity and TGA performed on the forth example and the first and forth comparison examples are shown in FIGS. 9 and 10.

FIG. 9 shows the ionic conductivity of the xCHS(100-x)Bz composite materials produced in the forth example and the specimens (cesium hydrogen sulfate, benzimidazole) prepared in the first and forth comparison examples. In FIG. 9, the horizontal axis indicates the temperature and the vertical axis indicates the conductivity. The ionic conductivity of the xCHS(100-x)Bz composite materials, the cesium hydrogen sulfate, and the benzimidazole are plotted in relation to temperature.

In FIG. 9, the plot markers shown as white circles, black downward-pointing triangles, white triangles, black squares, and white squares, respectively, indicate the ionic conductivity of the xCHS(100-x)Bz composite materials in which x are 90, 80, 70, 60, and 50. Furthermore, in FIG. 9, the black circle plot markers indicate the ionic conductivity of the cesium hydrogen sulfate and the black diamond plot markers indicate the ionic conductivity of the benzimidazole.

FIG. 10 shows the thermogravimetric changes of the xCHS(100-x)Bz composite materials and the specimens (cesium hydrogen sulfate, benzimidazole) prepared in the first and forth comparison examples. In FIG. 10, the horizontal axis indicates the temperature and the vertical axis indicates the weight fraction. The codes assigned for individual composite materials are shown next to the curves showing the thermogravimetric changes of the individual composite materials. In FIG. 10, the label “CsHSO₄” is shown next to the curve showing the thermogravimetric change of the cesium hydrogen sulfate, and the label “Benzimidazole” is shown next to the curve showing the thermogravimetric change of the benzimidazole. In FIG. 10, the curve showing the thermogravimetric change of the raw benzimidazole prepared under the same milling conditions as the forth example is shown as a reference, to which the label “MM-Benzimidazole” is assigned.

As can be seen in FIG. 9, the ionic conductivity properties of the xCHS(100-x)Bz composite materials improved in a case where the mole ratio of the cesium hydrogen sulfate was 60 or more at least in the temperature range from around 100° C. up to 140° C. compared to those of the cesium hydrogen sulfate and benzimidazole. Moreover, the ionic conductivity of the 70CHS30Bz and 80CHS20Bz composite materials improved more than that of the cesium hydrogen sulfate and benzimidazole in the temperature range from 60° C. to 140° C. In a case where the temperature exceeded 140° C., the ionic conductivity of substantially 10⁻³ Scm⁻¹ was achieved.

Furthermore, as shown in FIG. 10, the thermal stability of the xCHS(100-x)Bz composite materials improved compared to that of the benzimidazole. In a case where the mole ratio of the cesium hydrogen sulfate was 50 or more in the xCHS(100-x)Bz composite materials, the effect became significant.

Here, benzimidazole became thermally unstable over 150° C. as shown in FIGS. 9 and 10. As shown in FIG. 10, the weight of the benzimidazole reduced rapidly from the vicinity of 180° C. Even though the benzimidazole has higher thermal stability than the triazole and imidazole, as shown in FIG. 9, only low ionic conductivity that did not exceed 10⁻⁶ Scm⁻¹ was exhibited even at 140° C. In a case where the mole ratio of the cesium hydrogen sulfate was 40 or less in the xCHS(100-x)Bz composite materials, high ionic conductivity was not achieved especially at 100° C. or less.

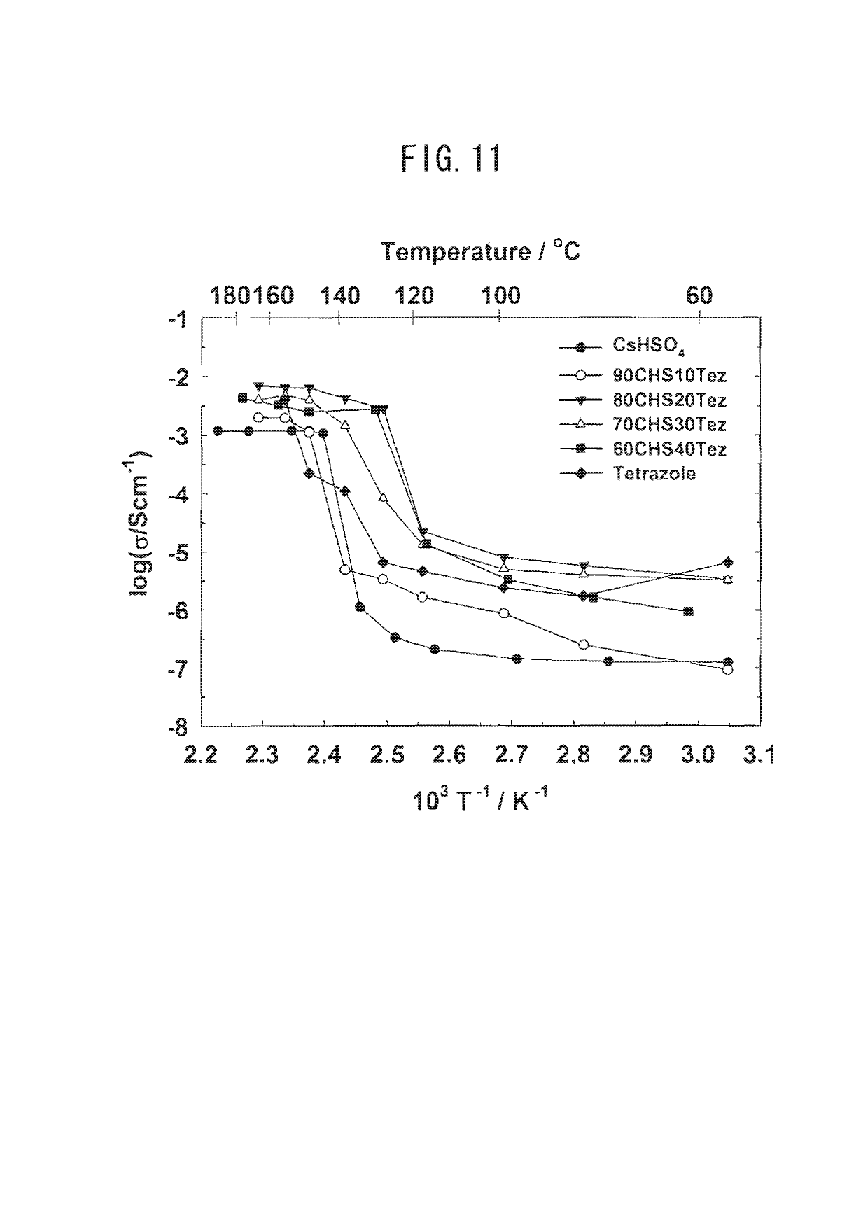

The results of the ionic conductivity measurement performed on the fifth example and the first and fifth comparison examples are shown in FIG. 11.

FIG. 11 shows the ionic conductivity of the xCHS(100-x)Tez composite materials produced in the fifth example and the specimens (cesium hydrogen sulfate, tetrazole) prepared in the first and fifth comparison examples. In FIG. 11, the horizontal axis indicates the temperature and the vertical axis indicates the conductivity. The ionic conductivity of the xCHS(100-x)Tez composite materials, the cesium hydrogen sulfate and the tetrazole are plotted in relation to temperature.

In FIG. 11, the plot markers shown as white circles, black downward-pointing triangles, white triangles, and black squares, respectively, indicate the ionic conductivity of the xCHS(100-x)Tez composite materials in which x are 90, 80, 70, and 60. Furthermore, in FIG. 11, the black circle plot markers indicate the ionic conductivity of the cesium hydrogen sulfate and the black diamond plot markers indicate the ionic conductivity of the tetrazole.

As can be seen in FIG. 11, the ionic conductivity of the xCHS(100-x)Tez composite materials improved in a case where the mole ratio of the cesium hydrogen sulfate was in a range from 60 to 80 at least in the temperature range from around 100° C. up to 140° C. compared to that of the cesium hydrogen sulfate and benzimidazole. The xCHS(100-x)Tez composite materials exhibited high ionic conductivity of over 10⁻³ Scm⁻¹ at 140° C.

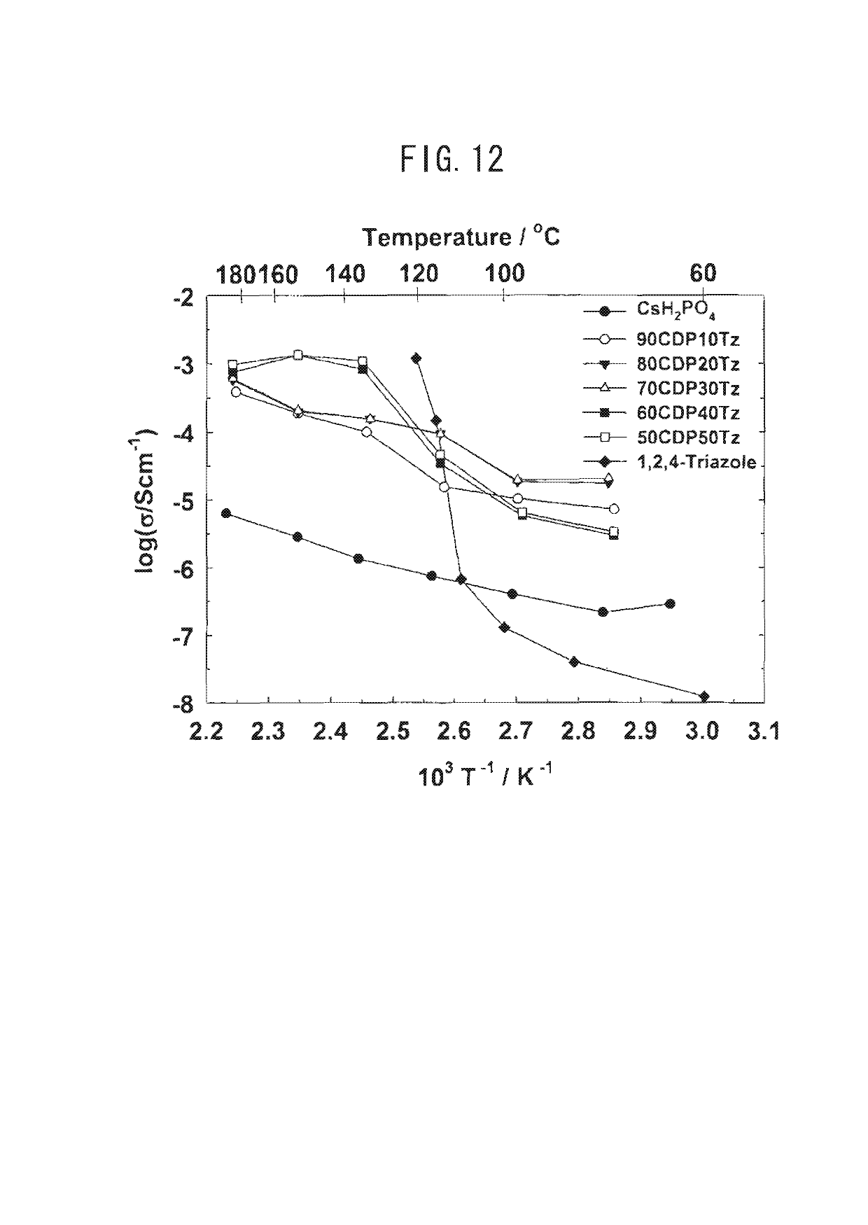

The results of the ionic conductivity measurement performed on the sixth example and the second and sixth comparison examples are shown in FIG. 12.

FIG. 12 shows the ionic conductivity of the xCDP(100-x)Tz composite materials produced in the sixth example and the specimens (triazole, cesium dihydrogen phosphate) prepared in the second and sixth comparison examples. In FIG. 12, the horizontal axis indicates the temperature and the vertical axis indicates the conductivity. The ionic conductivity of the xCDP(100-x)Tz composite materials, the cesium dihydrogen phosphate and the triazole are plotted in relation to temperature.

In FIG. 12, the plot markers shown as white circles, black downward-pointing triangles, white triangles, black squares, and white squares, respectively, indicate the ionic conductivity of the xCDP(100-x)Tz composite materials in which x are 90, 80, 70, 60, and 50. Furthermore, in FIG. 12, the black circle plot markers indicate the ionic conductivity of the cesium dihydrogen phosphate and the black diamond plot markers indicate the ionic conductivity of the triazole.

As can be seen in FIG. 12, the xCDP(100-x)Tz composite materials had good ionic conductivity properties over 120° C. even up to 180° C. The ionic conductivity significantly improved compared to that of the cesium dihydrogen phosphate. Especially, the 50CDP50Tz and 60CDP40Tz composite materials exhibited high proton conductivity properties that reached 10⁻³ Scm⁻¹ at 140° C.

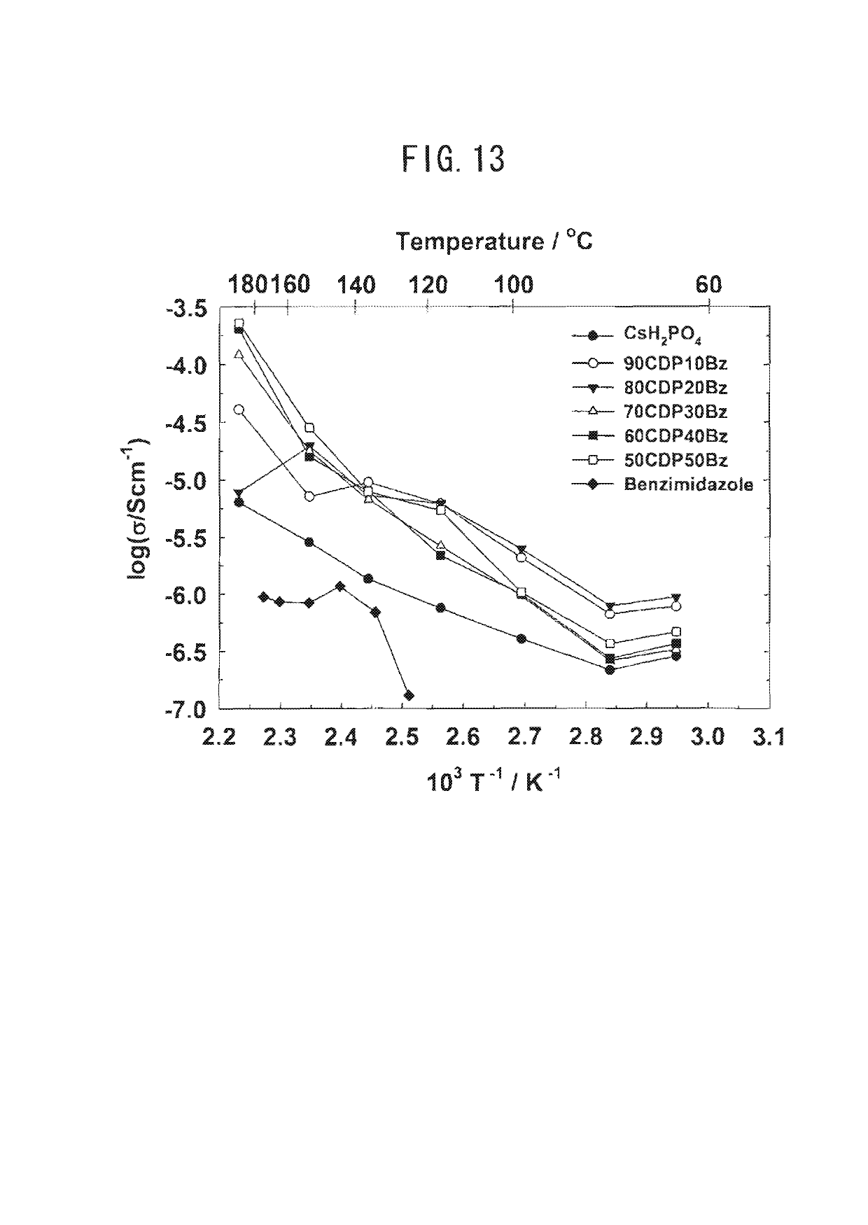

The results of the ionic conductivity measurement performed on the seventh example and the forth and sixth comparison examples are shown in FIG. 13.

FIG. 13 shows the ionic conductivity of the xCDP(100-x)Bz composite materials produced in the seventh example and the specimens (benzimidazole, cesium dihydrogen phosphate) prepared in the forth and sixth comparison examples. In FIG. 13, the horizontal axis indicates the temperature and the vertical axis indicates the conductivity. The ionic conductivity of the xCDP(100-x)Bz composite materials, the cesium dihydrogen phosphate, and the benzimidazole are plotted in relation to temperature.

In FIG. 13, the plot markers shown as white circles, black downward-pointing triangles, white triangles, black squares, and white squares, respectively, indicate the ionic conductivity of the xCDP(100-x)Bz composite materials in which x are 90, 80, 70, 60, and 50. Furthermore, in FIG. 13, the black circle plot markers indicate the ionic conductivity of the cesium dihydrogen phosphate and the black diamond plot markers indicate the ionic conductivity of the benzimidazole.

As can be seen in FIG. 13, the ionic conductivity of the xCDP(100-x)Bz composite materials was higher than that of the cesium dihydrogen phosphate and benzimidazole. Specifically, the ionic conductivity of the benzimidazole was as low as approximately 10⁻⁶ Scm⁻¹ at 180° C. while the ionic conductivity of the cesium dihydrogen phosphate was as low as substantially 10⁻⁵ Scm⁻¹ at 180° C. However, in a case where the mole ratio of the cesium dihydrogen phosphate was 50 or more in the xCDP(100-x)Bz composite materials, the ionic conductivity of the xCDP(100-x)Bz composite materials became higher than that of the cesium dihydrogen phosphate and benzimidazole in the temperature range from 60° C. to 180° C. The 50CDP50Bz, 60CDP40Bz, and 70CDP30Bz composite materials exhibited proton conductivity properties that exceeded 10⁻⁴ Scm⁻¹ at 180° C.

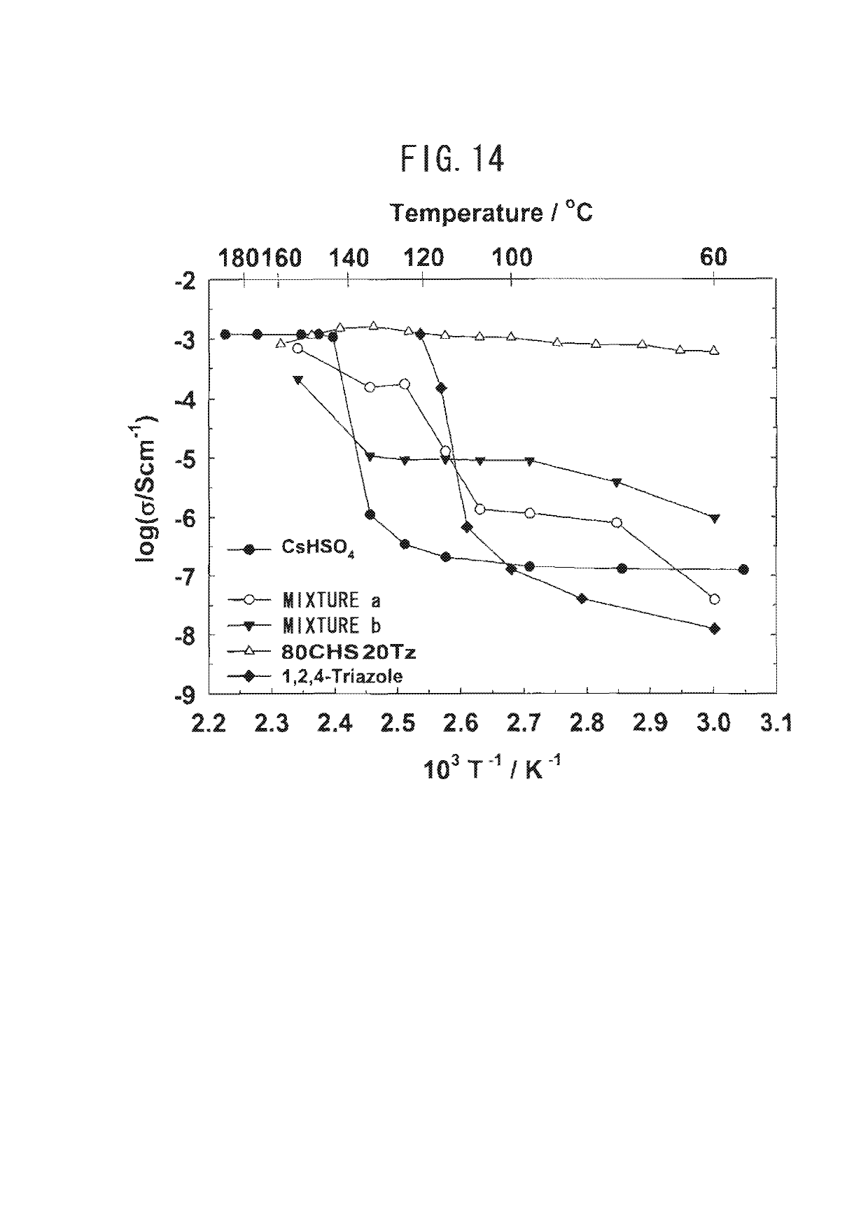

The results of the ionic conductivity measurement performed on the seventh and eighth comparison examples are shown in FIG. 14.

FIG. 14 shows the ionic conductivity of the mixture a produced in the seventh comparison example, the mixture b produced in the eighth comparison example, the 80CHS20Tz composite material produced in the first example, the cesium hydrogen sulfate prepared in the first comparison example, and the triazole prepared in the second comparison example. In FIG. 14, the horizontal axis indicates the temperature and the vertical axis indicates the conductivity. The ionic conductivity of the 80CHS20Tz composite material of the first example, the mixture a, the mixture b, the cesium hydrogen sulfate, and the triazole are plotted in relation to temperature.

In FIG. 14, the plot markers shown as white circles, black downward-pointing triangles, and white triangles, respectively, indicate the ionic conductivity of the mixture a, the mixture b, and the 80CHS20Tz composite material. Furthermore, in FIG. 14, the black circle plot markers indicate the ionic conductivity of the cesium hydrogen sulfate and the black diamond plot markers indicate the ionic conductivity of the triazole.

As can be seen in FIG. 14, the ionic conductivity of each of the mixture a and the mixture b was lower than that of the 80CHS20Tz composite material. It was confirmed that it was not possible, ie, impossible, to produce a composite material from the solid inorganic acid salt and the azole compound by simply mixing the solid inorganic acid salt and the azole. It was also confirmed that forming a composite material from the two materials make it possible to achieve high proton conductivity properties in a medium temperature region and to improve proton conductivity properties at low temperatures of 100° C. or less.

Given the results that are described above, it is concluded that the composite material produced by mixing the acid salt of the oxo acid compound and the azole compound can achieve high ionic conductivity of 10⁻³ Scm⁻¹ under medium temperature, non-humidified conditions. It is also concluded that the composite material exhibits high ionic conductivity from low temperatures of 100° C. or less. Put another way, the proton conductor that is achieved has good proton conductivity properties under medium temperature, non-humidified conditions and that is operatable at low temperature. Moreover, counter ions that transfer through the proton conductor can be reduced, making it possible to improve the proton transport number as well as to achieve higher power generation efficiency.

1. A proton conductor comprising:
a composite material that is produced by mechanical mixing of an azole compound and a solid inorganic acid salt that contains an acid salt of an oxo acid.

2. The proton conductor according to claim 1, wherein
the acid salt is a salt in which an acidic group of the oxo acid is bonded to one of an alkaline metal ion and an ammonium ion by an ionic bond.

3. The proton conductor according to claim 1, wherein
a mole ratio of the solid inorganic acid salt in relation to the azole compound is one or more.

4. A proton conductor comprising:
a composite material that contains an azole compound and a solid inorganic acid salt that contains an acid salt of an oxo acid.

5. The proton conductor according to claim 4, wherein
a mole ratio of the solid inorganic acid salt in relation to the azole compound is one or more.

6. The proton conductor according to claim 4, wherein
the acid salt is a salt in which an acidic group of the oxo acid is bonded to one of an alkaline metal ion and an ammonium ion by an ionic bond.

7. The proton conductor according to claim 1, wherein
the azole compound contains two or more nitrogen atoms in a heterocyclic 5-membered ring.

8. The proton conductor according to claim 7, wherein the azole compound is a triazole.

9. A method of producing a proton conductor, comprising:
a mixing process of producing, by mechanical mixing of an azole compound and a solid inorganic acid salt that contains an acid salt of an oxo acid, a composite material containing the azole compound and the solid inorganic acid salt.

10. The method of producing the proton conductor according to claim 9, wherein
the acid salt is a salt in which an acidic group of the oxo acid is bonded to one of an alkaline metal ion and an ammonium ion by an ionic bond.

11. The method of producing the proton conductor according to claim 9, wherein
the mixing process is performed by mixing the solid inorganic acid salt and azole compound, a mole ratio of the solid inorganic acid salt in relation to the azole compound being one or more.

12. The method of producing the proton conductor according to claim 9, wherein
the azole compound contains two or more nitrogen atoms in a heterocyclic 5-membered ring.

13. The method of producing the proton conductor according to claim 12, wherein
the azole compound is a triazole.

14. The method of producing the proton conductor according to claim 9, wherein
the mixing process is performed by milling processing that uses a planetary ball mill.

15. The proton conductor according to claim 4, wherein
the azole compound contains two or more nitrogen atoms in a heterocyclic 5-membered ring.

16. The proton conductor according to claim 15, wherein
the azole compound is a triazole.

17. The proton conductor according to claim 1, wherein
the azole compound includes one of azole, diazole, triazole, tetrazole, an azole derivative, a diazole derivative, a triazole derivative, and a tetrazole derivative,
the composite material is produced by mechanochemical processing on the azole compound and the solid inorganic acid salt,
the acid salt of the oxo acid contains an oxo acid anion and one of an alkaline metal ion and an ammonium ion, and
the composite material includes a hydrogen bond network formed between the oxo acid anion in the acid salt of the oxo acid and the azole compound.

18. The proton conductor according to claim 4, wherein
the azole compound includes one of azole, diazole, triazole, tetrazole, an azole derivative, a diazole derivative, a triazole derivative, and a tetrazole derivative,
the acid salt of the oxo acid contains an oxo acid anion and one of an alkaline metal ion and an ammonium ion, and
the composite material includes a hydrogen bond network formed between the oxo acid anion in the acid salt of the oxo acid and the azole compound.

19. The method of producing the proton conductor according to claim 9, wherein
the azole compound includes one of azole, diazole, triazole, tetrazole, an azole derivative, a diazole derivative, a triazole derivative, and a tetrazole derivative,
the composite material is produced by mechanical milling of the azole compound and the solid inorganic acid salt in the mixing process,
the acid salt of the oxo acid contains an oxo acid anion and one of an alkaline metal ion and an ammonium ion, and
the composite material includes a hydrogen bond network formed between the oxo acid anion in the acid salt of the oxo acid and the azole compound.
